(19) United States
(12) Patent Application Publication
(10) Pub. No.: US 2002/0019798 A1
(43) Pub. Date: Feb. 14, 2002

(54) System and method of collecting, processing, and displaying stock certificate data over a computer network

(76) Inventor: Dilip Gajendragadkar, New York, NY (US)

Correspondence Address: Pennie & Edmonds, LLP, 3300 Hillview Avenue, Palo Alto, CA, 94304, US

(21) Appl. No.: 09/813,673

(22) Filed: Mar. 21, 2001

Related U.S. Application Data
(63) Continuation-in-part of application No. 09/636,588, filed on Aug. 10, 2000.

(51) Int. Cl. G06F 17/60

(52) U.S. Cl. 705/37; 705/35

(57) ABSTRACT

A communications network based system and method for receiving and parsing data related to a stock certificate, creating a stock certificate holdings record from this data, and displaying this record to the holder. The system and method comprises receiving data related to a stock certificate. Once the data is received, it is parsed to identify the constituent elements of the data. After the constituent elements of the data are parsed, a stock certificate holdings record is created a holder identified in the data. Having the data sooner enables the holder to initiate the process of delegending and/or selling the stock certificate identified in the data.

This application is a continuation-in-part of Ser. No. 09/636,588, filed Aug. 10, 2000, entitled, “SYSTEM AND METHOD OF CLEARING SALES OF RESTRICTED SECURITIES.”

### BRIEF DESCRIPTION OF THE INVENTION

The present invention discloses a system and method for receiving and parsing data related to a stock certificate, creating a stock certificate holdings record from this data, and displaying this record to the holder.

### BACKGROUND OF THE INVENTION

Currently, designated recipients of stock certificates must wait until a stock certificate has been received before receiving usable information regarding the stock certificate. Due to the lack of information, the stock holder often can not begin the process of delegending and/or selling the stock certificate.

For example, a holder of stock certificates of a corporation that is subject to a merger or acquisition, often does not have information about a replacement stock certificate that will be issued in exchange for the stock certificate already held. Specifically, several weeks can pass before the information is received by the holder even though the information resides with the issuer, or agent of the issuer, of the stock on the day of the transaction in most cases. Thus, the issuer currently has no means for transferring this information to the stock holder in a timely fashion. Similarly, holders who receive stock certificates as a result of an IPO face similar issues.

There is needed therefore, a system and method for transmitting information regarding a stock certificate, so that the holder can access the information regarding the stock certificate sooner, and optionally begin the process of delegending and/or selling the stock certificate.

### SUMMARY OF THE INVENTION

The present invention includes a system and method for creating a stock certificate holdings record. The method comprises receiving data related to a stock certificate held by a holder of the stock certificate and parsing the data to identify its constituent elements. After the constituent elements of the data have been parsed, a stock certificate holdings record is created for a holder identified in the data. The stock certificate holdings record is then displayed to the holder upon request by the holder.

### BRIEF DESCRIPTION OF THE DRAWINGS

FIG. 1 is a schematic diagram illustrating an overview of the present system;

FIG. 2 is a schematic diagram illustrating a server configured in accordance with a preferred embodiment of the present system;

FIG. 3 is a schematic diagram illustrating a user computer configured in accordance with a preferred embodiment of the present system;

FIGS. 4A-4D are process diagrams describing actions of a single holder and events triggered by the actions of the holder in Stage I of Process I to delegend one or more restricted stocks.

FIGS. 5A-5B are process diagrams depicting actions of the Brokerage Firm or a representative of the Holder and events triggered by these actions during Stage II of Process I to delegend restricted stocks.

FIGS. 6A-6C are process diagrams of Stage III and Stage IV of Process that depict actions of the Issuer of the restricted stocks and the Internal or Outside Counsel of the Issuer of the restricted stocks and the events triggered by these actions.

FIGS. 7A-7C are process diagrams describing actions of the Transfer Agent of the Issuer and events triggered by these actions during Stage V of Process I directed to delegend restricted stocks.

FIGS. 8A-8D are process diagrams describing actions of a venture capital fund representative and events triggered by these actions during Stage I of Process II directed to the distribution of restricted stock held by a fund of a General Partnership (Venture Capital Partnership, Private Equity Partnership etc.) (“VC fund”) to the partners of the VC fund.

FIGS. 9A-9C are process diagrams describing actions of the Internal or Outside Counsel of the Issuer of the Stocks held by the venture capital fund and events triggered by these actions during Stage II of Process II directed to the distribution of restricted stock held by a VC fund to its partners.

FIGS. 10A-10C are process diagrams describing actions of the Transfer Agent of the Issuer of the Stocks held by the VC fund and events triggered by these actions during Stage III of Process II directed to the distribution of restricted stock held by a VC fund to the partners of the VC fund.

FIG. 11 is a process diagram describing the process of creating a stock certificate holdings record consistent with a preferred embodiment of the present invention.

### DETAILED DESCRIPTION OF THE PREFERRED EMBODIMENT

The present invention creates an Internet-based, or other network-based, process for managing the data, approvals, and documentation necessary for removal of restrictive legends from stock certificates (“delegending”, “delegend”) and for settlement of trades of restricted stock. The invention creates a process by which the actions, approvals, and documents of the various entities involved in the process are recorded, monitored, generated and communicated. Additionally, as each stage of the process is completed, automated notifications are sent to various entities involved in the process.

The invention also creates an Internet-based, or other network-based, process for managing, recording and monitoring the steps involved in the distribution of restricted stock held by a fund of a Venture Capital Firm, Private Equity Partnership, and other such Limited Partnership Entity. As each stage of the process is completed, automated notifications are sent to the relevant entities. As a result of this distribution, each partner of a fund of a Venture Capital Firm, Private Equity Partnership (“VC Firm”), and other such Limited Partnership Entity can use the invention to delegend restricted stocks distributed to them.

More specifically, in a preferred embodiment, the invention provides a Website and a database. The Website allows the various entities involved in the process to receive notifications, select actions pending their intervention, perform their tasks, and generate automatic notifications to the entities that require notification. All the respective entities involved in the process also use the Website to access their records and the relevant portion of action records that are pending their intervention.

An embodiment of the invention creates a record of the actions initiated by Holders or a Venture Capital Firm, Private Equity Partnership, or other such Limited Partnership Entity fund representative (“VC fund”). At each stage of the process, the record of the action is updated to reflect the progress. Documents are stored in the database and are updated automatically based on the actions. Automated notifications are sent to the appropriate entities that have to approve the documents and generate their own documents or have already done so. The document forwarding, approval, and generation process is done via an Internetbased, or other network-based, process. A record of each action by the various entities is kept and the necessary notifications are sent via an automatic notification process.

The database contains records of the various entities that are involved in the process, including Holders, VC funds, Issuers, Legal Counsels, Transfer Agents, Brokerage Agents.

Each Holder has a record. Holders are individuals, corporations, trusts, or institutions. This record contains basic information of the Holder including the name, Tax-ID, contact information, authorized persons list and documentation regarding authorized persons.

In addition, the Holder record contains a sub-record for each of the individual holdings of restricted stock owned by the Holder. The sub-record contains information including the Issuer of the stock, stock certificate number, legend type, legend text, affiliate status of the Holder, date of acquisition, date of automatic legend restriction change or termination, manner of acquisition, and broker information if relevant. This record also contains links to the records of the Issuer, Broker as needed.

In addition, the Holder record contains a sub-record for each VC fund of which the Holder is a limited partner. This sub-record contains links to the records of each VC fund involved.

The database includes records for VC Firns. A VC Firm record contains the basic information of the VC Firm including the name, address, tax-id, contact information, authorized persons list & documentation with a sub-record for each VC fund of the VC Firm.

The VC fund sub-record contains information regarding the partners of the VC fund (with links to the Holder record of each limited partner), a breakdown of the interests of the partners, and information and documents regarding distribution mechanisms of the fund.

In addition, the VC fund sub-record contains a sub-record for each restricted stock held by the fund. This sub-record is similar to the sub-record of holdings in a Holder record as described earlier.

The database also contains records of the Issuers of restricted stock. The Issuer record contains basic information regarding the Issuer including name, address, contact information, authorized persons list & documentation, affiliates list (with links to the Holder record of each affiliate), Legal Counsel name (with links to the Legal Counsel record), and Transfer Agent names (with link to the Transfer Agent record). The record of the Issuer also contains procedures and documents for restricted stock actions, and other relevant information.

The database also contains records for the Legal Counsel that serve the Issuers. The Legal Counsel record contains basic information such as name, address, and tax-id. This record also contains a sub-record for every Issuer that the Firm serves as Legal Counsel (with links to the Issuer record and the record of the Transfer Agent of the Issuer) containing the authorized persons list for acting for the specific Issuer. Further, the record also contains procedures, documents, and opinions about the tasks performed by the Legal Counsel.

The database contains records for Transfer Agents of Issuers. The Transfer Agent record contains basic information such as name, address, tax-id, authorized persons list & documentation, information regarding physical delivery, and Deposit Trust Corporation delivery information. This record also contains a sub-record for each Issuer served by the Transfer Agent (with links to the Issuer record and respective Legal Counsel record). This sub-record also contains a list of authorized persons at the Transfer Agent working with the Issuer and procedures and documentation for tasks performed by the Transfer Agent.

The database also contains records for Brokers that work with Holders. These records contain basic information about the respective entities and sub-records for each Holder account.

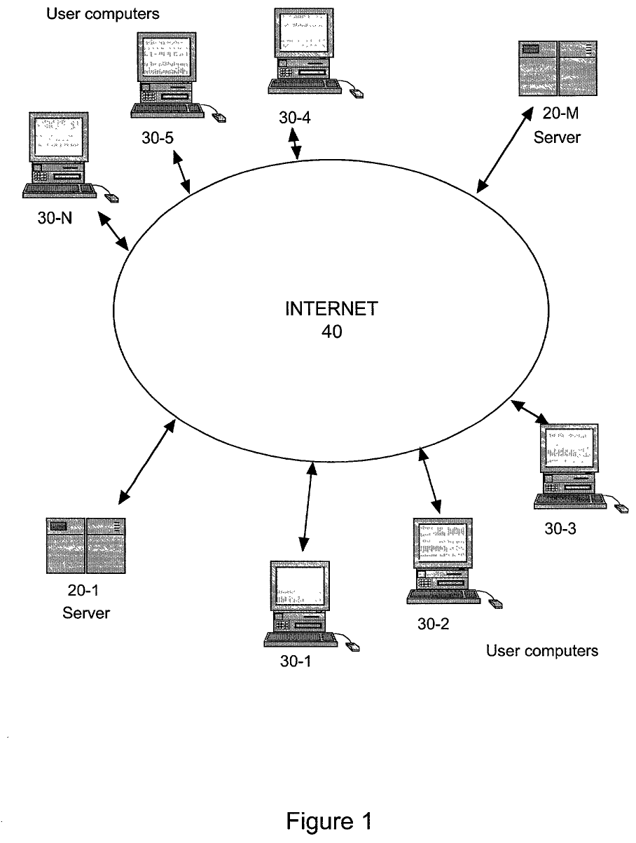

Reference is now made to FIG. 1, which is a schematic diagram illustrating an overview of the system of the present invention. Server 20 is connected to user customer 20 via a communications network, such as Internet 40.

Not included in FIG. 1, but likely included in a preferred embodiment of the invention are routers, load balancing switches, fire walls, and switches. Persons skilled in the art will recognize that these elements are often included in systems designed to interface with users via Internet 40. These elements provide requisite levels of security and robustness required by the present invention. Also not included in FIG. 1 were the many means of accessing Internet 40 from user computer 30. For example, user computer 30 can reside behind a corporate firewall on a local area network. In that case, the local area network is possibly connected to an Internet Service Provider via dedicated T1 line. Additionally, user computer 30 can also connect to Internet 40 directly through an Internet Service Provider through a dial-up connection or cable modem.

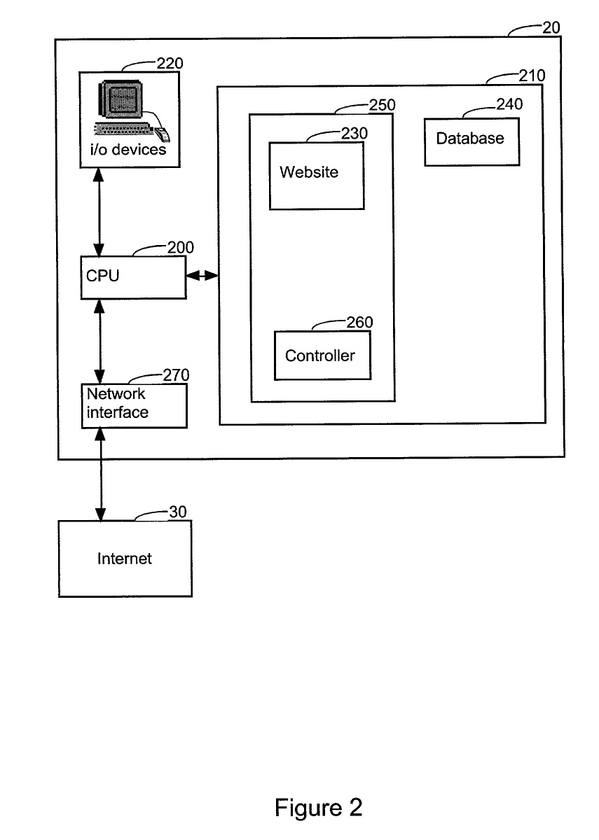

FIG. 2 includes a schematic diagram illustrating server 20 configured in accordance with a preferred embodiment of the present invention. Server 20, is preferably a programmed general purpose computer that includes processor 200, memory 210, i/o devices 220, and Website 230 that is accessible via Internet 40. As shown, memory 210 preferably includes database 240, and computer programs 250 for operating server 20 in accordance with an embodiment of the invention. In particular, controller 260 operates server 20 generally and performs the operations unique to the present invention. For example, controller 260 processes commands received from user computer 30 through Website 230, and if necessary, writes to or reads from database 240, in accordance with the present invention. Server 20 also includes network interface 270, which provides access to Internet 40. As is well known in the art, database 240 can be located apart from server 20 and connected thereto by a communications network. For example, database 240 can be maintained on multiple database servers. Additionally, Website 230 can resided on a dedicated web server. Finally, as indicated in FIG. 1 multiple servers 10 are available to interact with user computer 10 in case the primary server 20 fails.

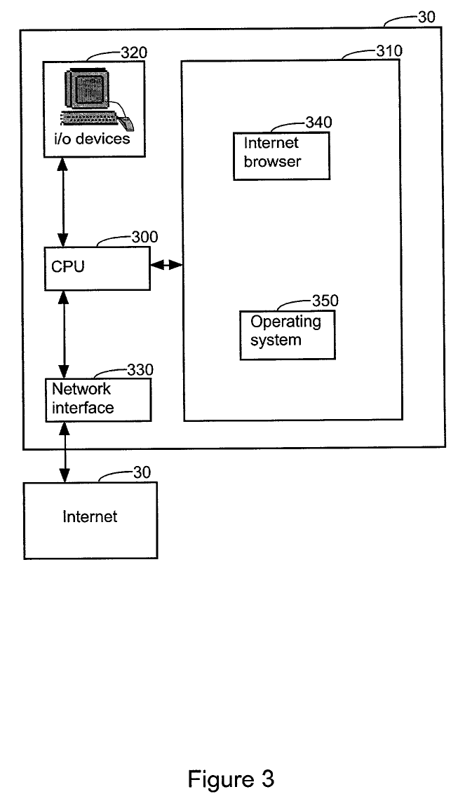

FIG. 3 includes a schematic diagram illustrating user computer 30 configured in accordance with a preferred embodiment of the present system. User computer 20 is also preferably a programmed general purpose computer that includes processor 300, memory 310, and i/o devices 320 such as a monitor, mouse, and keyboard. User computer 20 also preferably has access to the Internet 40 through network interface 330. As shown, memory 310 preferably includes Internet browser 340 and operating system 350, which controls the general functionality of user computer 30. User computer 20 may take many forms. Exemplary forms include personal computers, personal digital assistants (e.g., palm pilots), Internet accessible office automation devices, Internet accessible home appliances, televisions, and digital telephones. Other forms that now exist, or are possible, are within the scope of this invention.

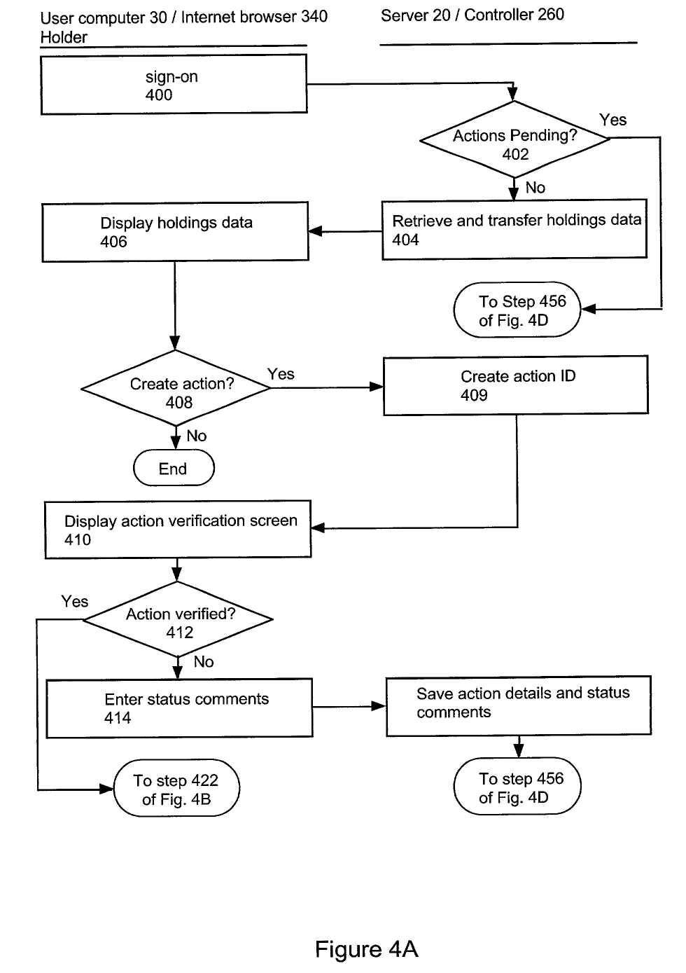

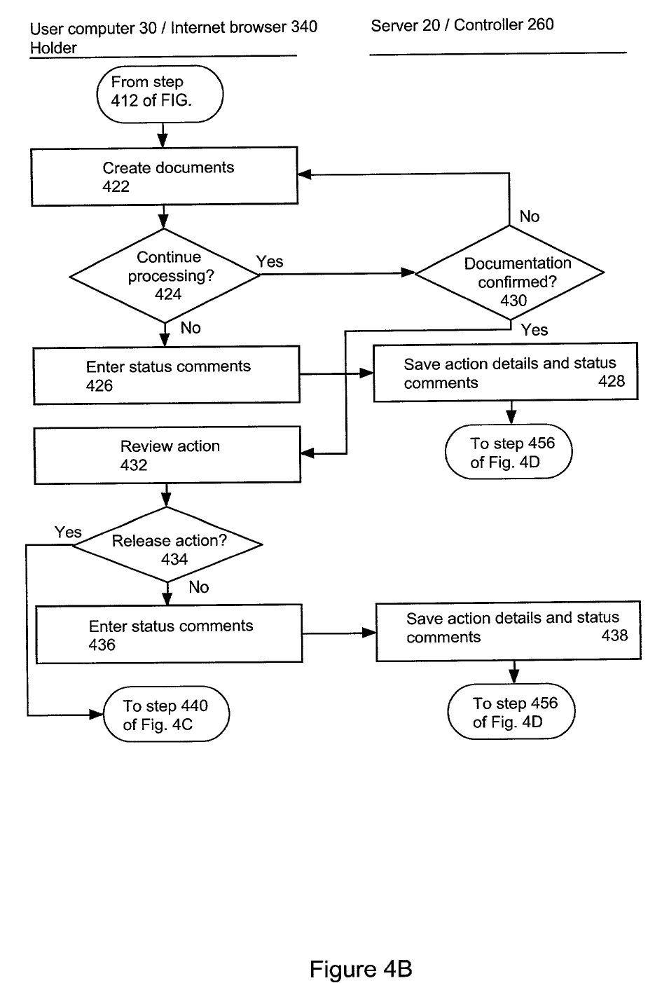

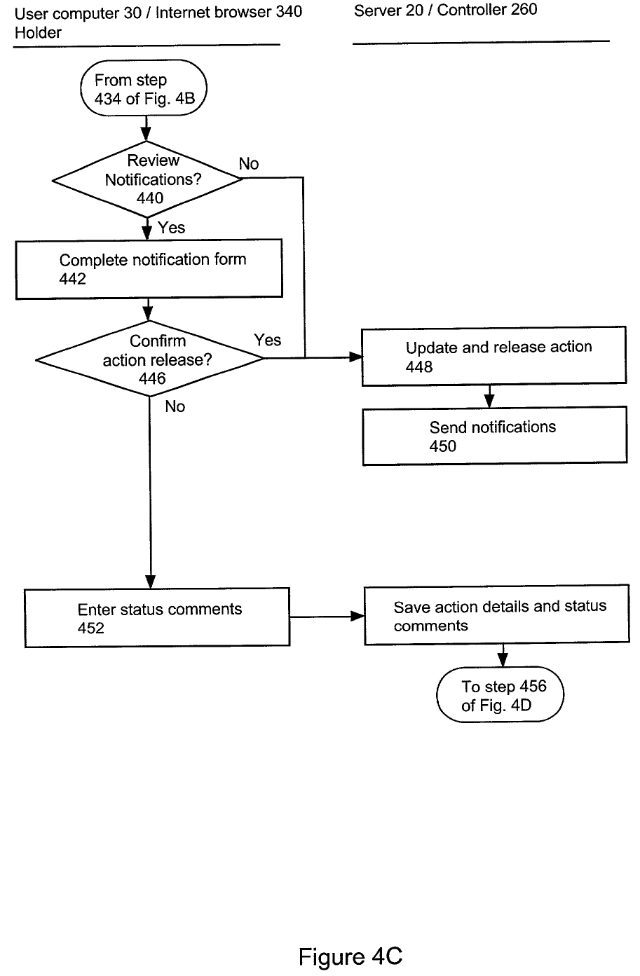

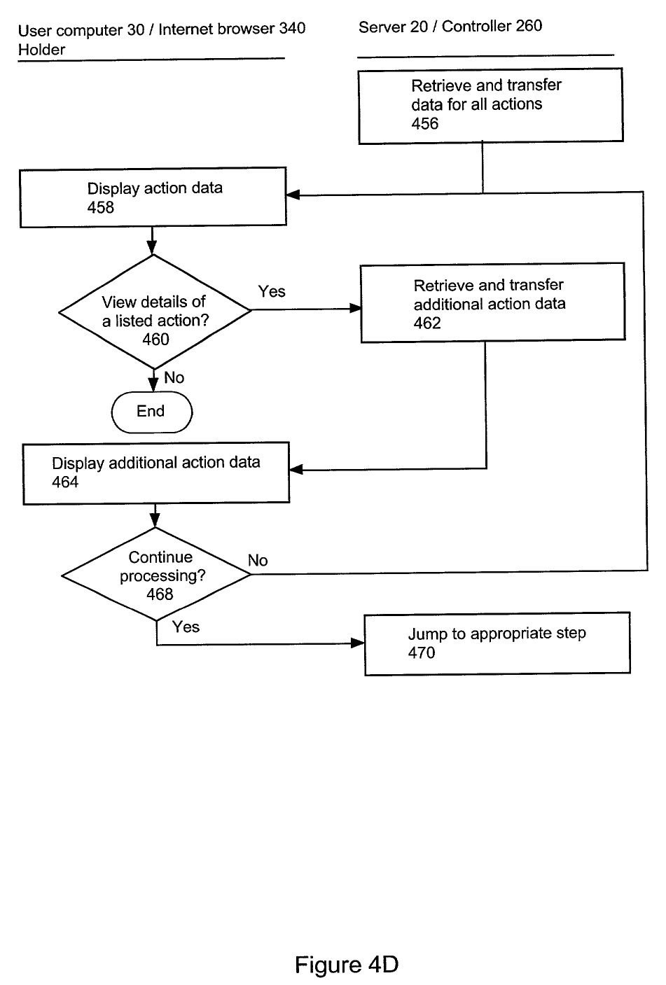

FIGS. 4A-4D are a process diagram of Stage I of Process I, which describes the actions of the Holder and the events triggered by the actions of the Holder. The Holder signs onto Server 20 of an embodiment of the invention and selects the specific stock certificates that the Holder wishes to process. Upon this action by the Holder, an embodiment of the invention retrieves the necessary documents from database 240. The data from the Issuer and the stock certificates selected by the Holder are merged into these documents. These documents are displayed to the Holder. The Holder executes these documents on or off-line. The Holder has the option of selecting a broker. The Holder then releases the action to the next stage of the process. The documents executed by the Holder are stored in database 240 and optionally printed. Automatic notifications (with the relevant detail including the action-ID) are sent to the entities pre-specified in the process. These entities include the Issuer, the Legal Counsel of the Issuer, and a Brokerage Firm if selected by the Holder. The notifications are delivered via email, fax, beeper, or Internet generated phone call. The mode of notification is preselected and stored in database 240. Preferably, these decisions are made when an account is created for a Holder. Similar steps are preferably taken for the other entities as well.

As an option, the process will allow automated, on-line filing of forms, such as Form 144, with the Securities and Exchange Commission as the SEC establishes a policy to accept such electronic filing. As an option selected by the Issuer, the actions of the Holder may be used to update the Form 4 of the Issuer.

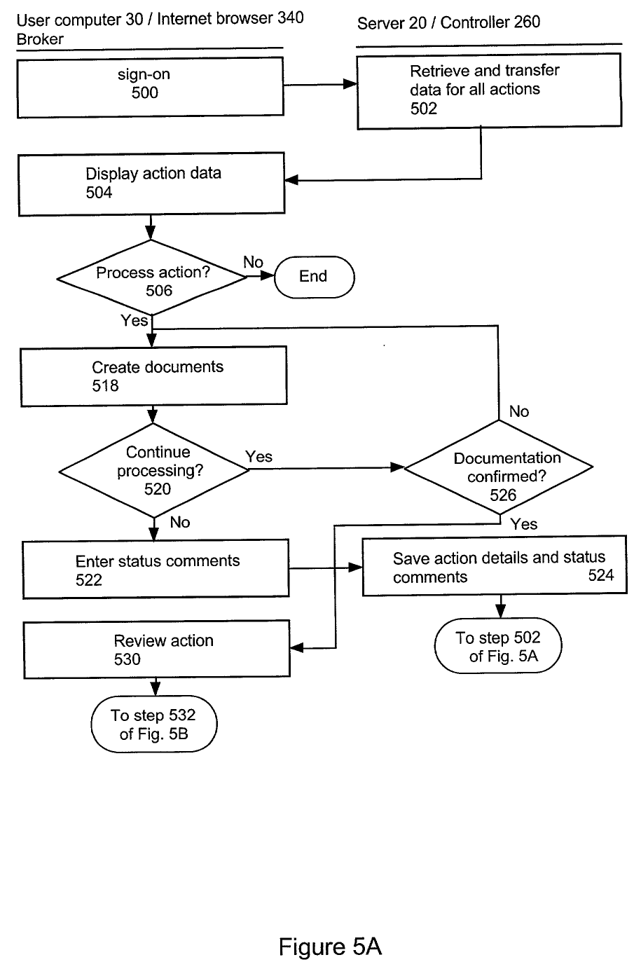

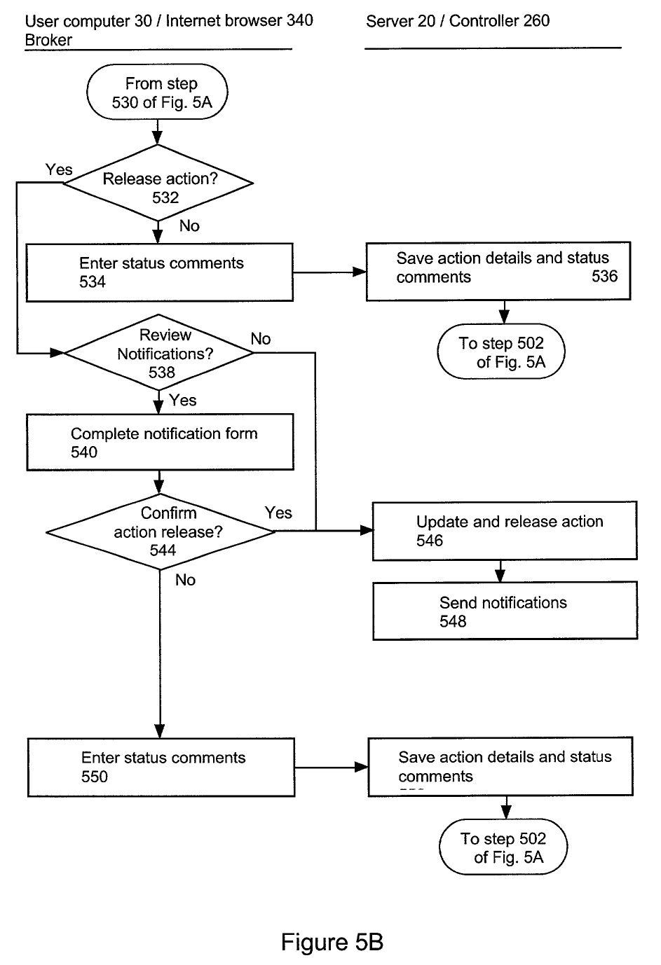

FIGS. 5A-5B are a process diagram of Stage II of Process I that describes the actions taken by a Broker employed by the Holder, a representative of the Holder, or the Holder and the events triggered by these actions. Recall that in Stage I, the Holder has the option of selecting a Broker. If a Broker is selected, the Broker completes this stage. Otherwise, the Holder works manually with the Broker and the Holder or the Holder's representatives execute this stage. However, for the sake of simplicity, this step is described with reference to a Broker. The Broker signs onto Server 20 and enters the records of the stock certificate sale if a sale has taken place. This would include the trade date and the sale price. At the option of the Holder, an automated notification is sent to the tax counsel of the Holder. If the Broker is the entity executing this step, the documents necessary for execution by the Broker are displayed to, and executed by, the Broker. These executed documents are stored in database 240 and optionally printed. Automated notifications are sent to all entities notified at the completion of Stage I. The action is released to Stage III.

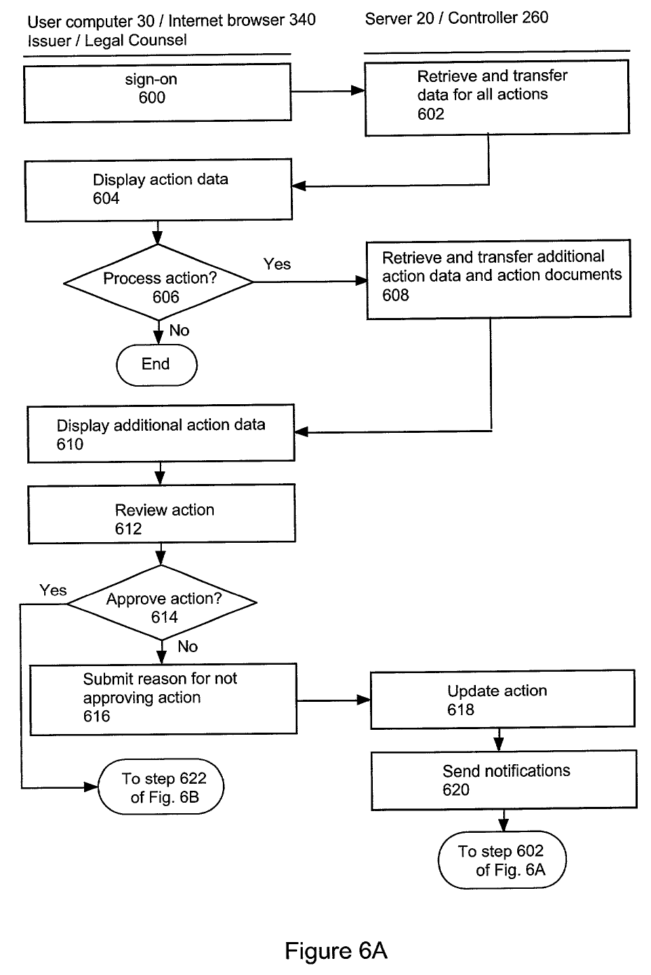

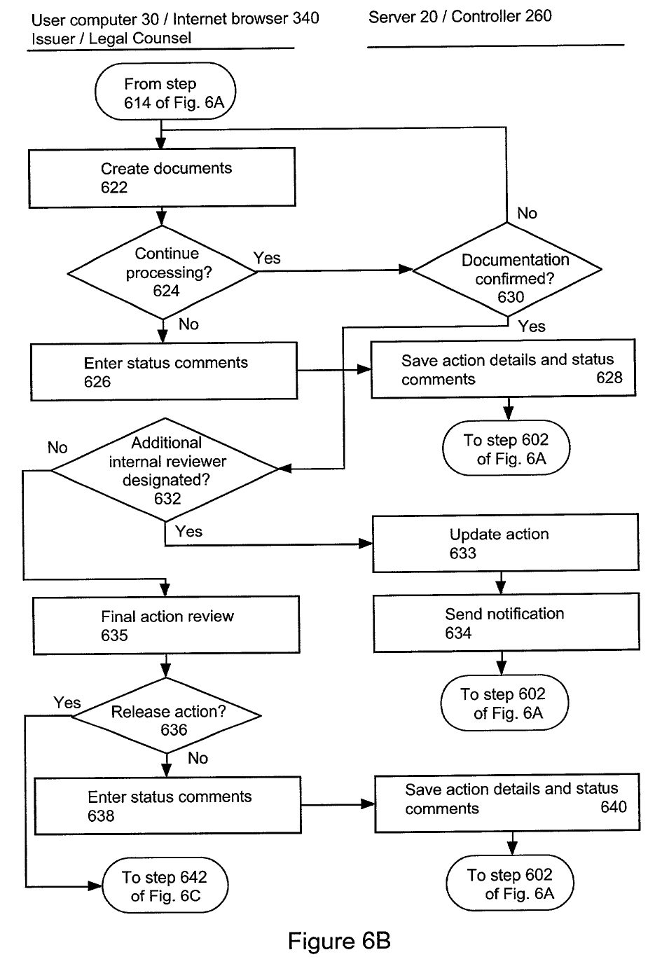

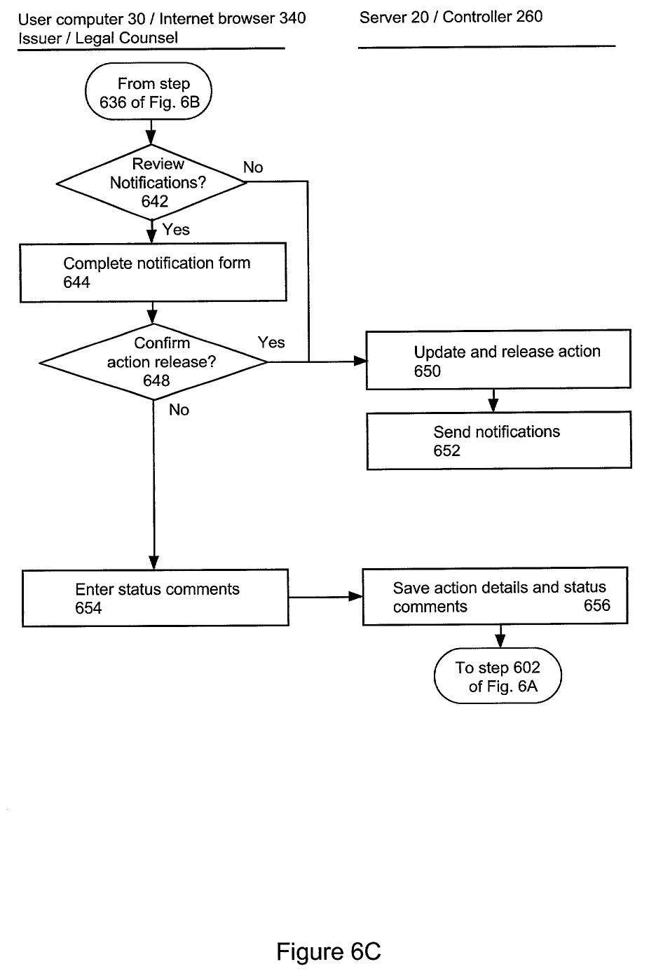

FIGS. 6A-6C are a process diagram of Stage III of Process I, which describes the actions of the Issuer of the stock that the Holder has selected to delegend and the events triggered by these actions. The Issuer is notified of the actions taken by the Holder in Stage I and the Broker in Stage II as described above. The Issuer signs onto Server 20. The Issuer selects a specific action preferably by selecting an action from a menu of all actions pending intervention by the Issuer. The Issuer then reviews the documents created by the Holder and the Broker. Next, the Issuer has the option of approving or disapproving each action. If the action is disapproved, the action is suspended and automatic notifications are sent to the Holder, Broker, and other relevant entities. If the action is approved, the Issuer then creates any needed documentation. Once processing is completed by the Issuer Automatic notifications are sent to the Legal Counsel, Holder and other entities notified at the completion of Stage II. The action is released to Stage IV.

FIGS. 6A-6C are also a process diagram of Stage IV of Process I, which describes the actions taken by Legal Counsel of the Issuer and the events triggered by these actions. The Legal Counsel signs on to Server 20 and selects an action. As in Stage II and Stage III, the action is preferably selected from a menu of actions pending intervention by the Legal Counsel. The Legal Counsel approves or disapproves the action. If the Legal Counsel disapproves the action, the action is suspended with the appropriate suspension code or reason and automatic notifications are sent to all entities notified at the completion of Stage III. If the action is approved, the relevant documents are retrieved from database 240, updated with the details about the specific action that is being approved. The resulting documents are then displayed. The Legal Counsel executes these documents, which are then stored in database 240 and optionally printed if executed on-line. Automatic notifications are sent to the Transfer Agent and all the other entities notified at the completion of Stage III. The action is released to stage V.

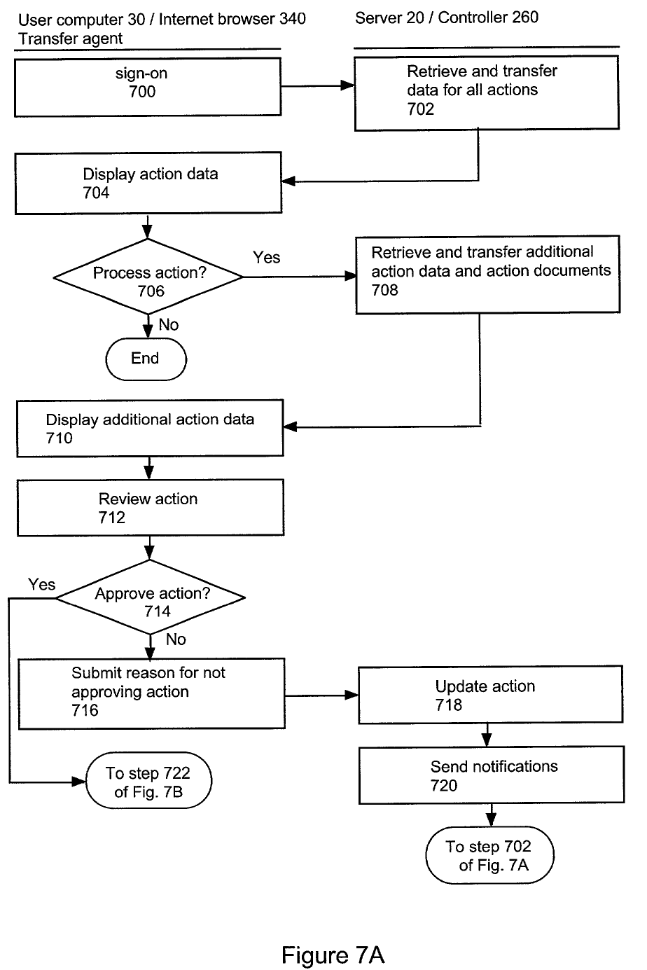

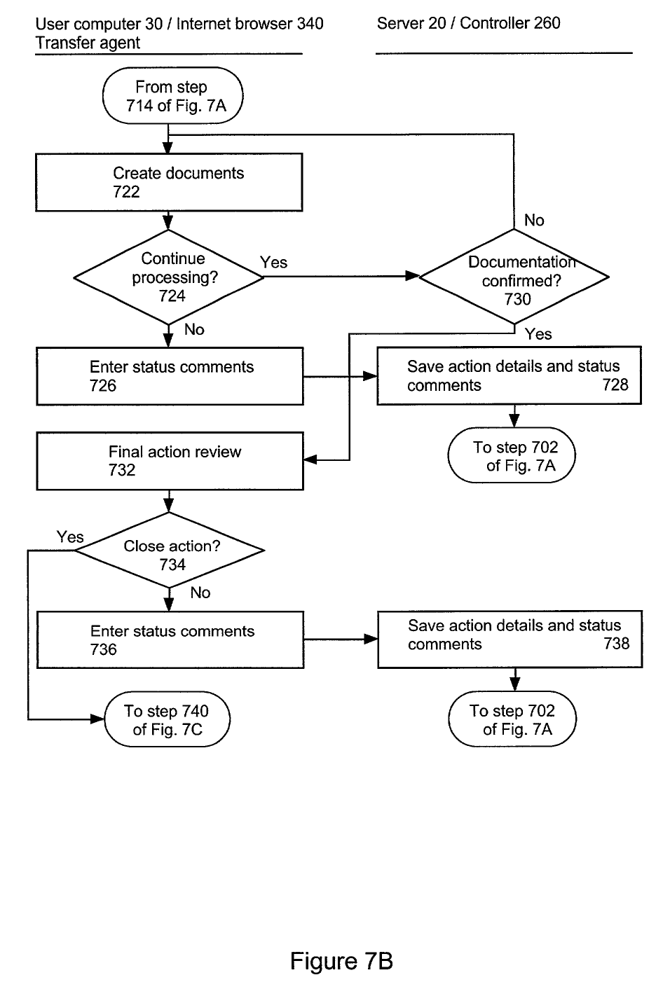

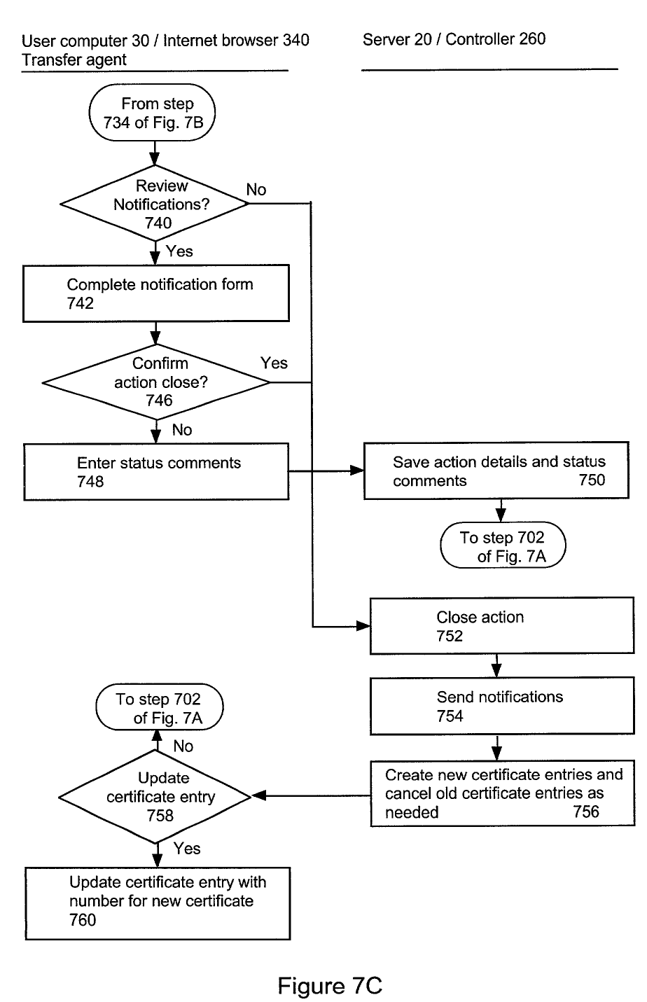

FIGS. 7A-7C are a process diagram of stage V of Process I, which describes the actions taken by a Transfer Agent of the Issuer and the events triggered by these actions including the successful completion of Process I. The Transfer Agent signs onto Server 20 and selects an action. As in earlier stages, the action is preferably selected from a menu of actions pending intervention by the Transfer Agent. The Transfer Agent suspends or closes the action. If the action is suspended, the specific requirements needed to accept the action, as submitted by the Transfer Agent, are stored in database 240 and automatic notifications are sent to all the entities notified at the completion of Stage IV. If the action is accepted, the Transfer Agent specifies the details of the steps performed by the Transfer Agent including updates of the stock certificate records and the Holder records. Automatic notifications are sent to all the entities notified at the completion of Stage IV. The action is now successfully completed and closed.

Process II is a diagrammatic depiction of the steps involved in the distribution of restricted stock by VC funds to their partners.

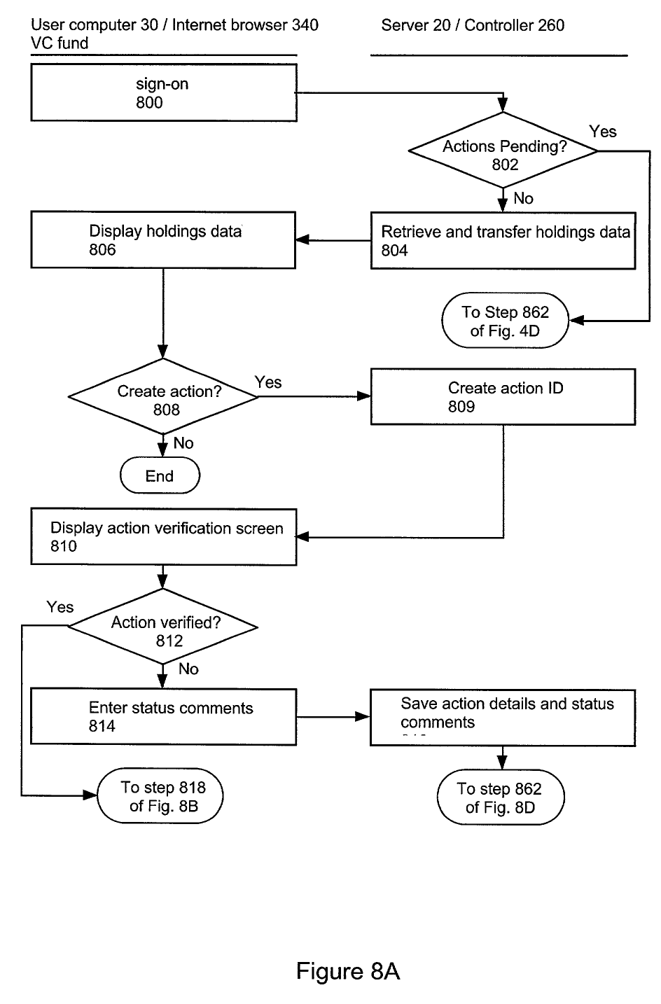

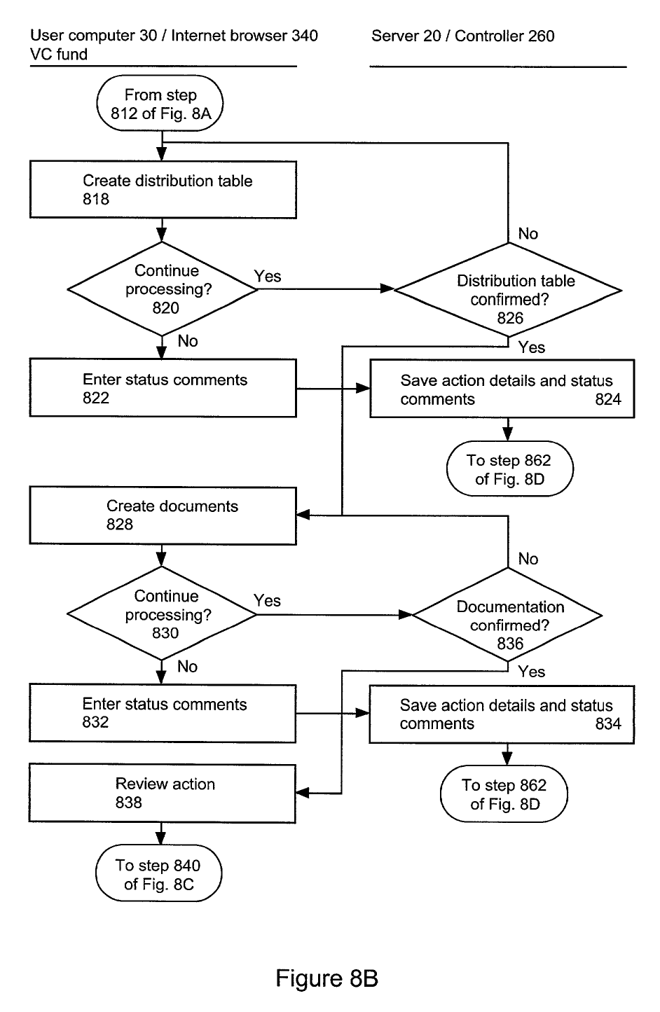

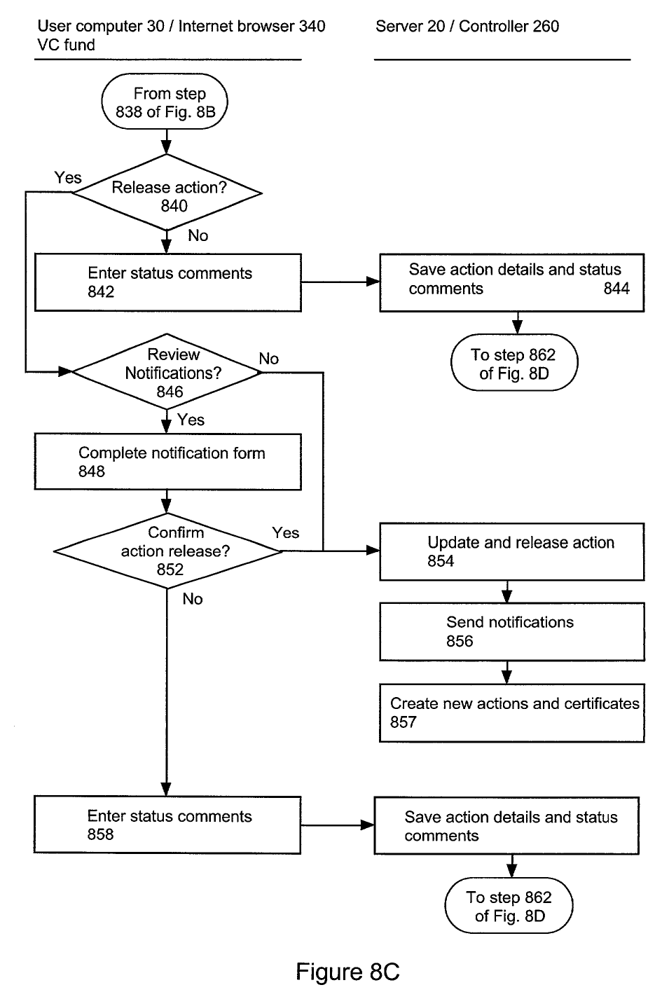

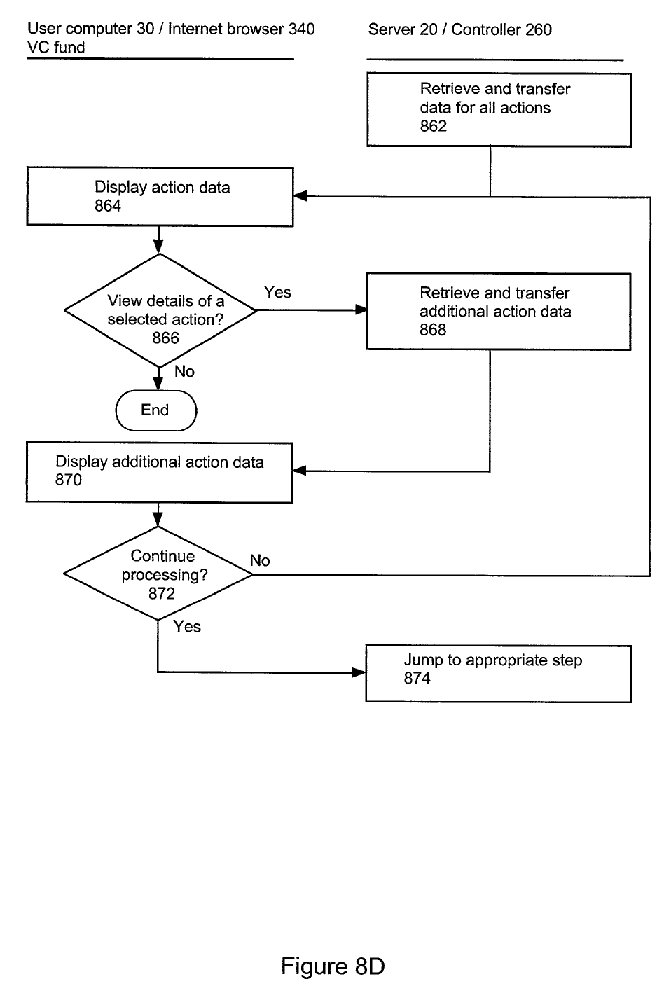

FIGS. 8A-8D are a process diagram of Stage I of Process II, which describes the actions taken by a VC fund and the events triggered by these actions. On the date of the distribution, the VC fund selects the Issuer, the specific stock certificates and selects the action. Preferably, the documents necessary to facilitate the distribution action are created by the VC fund and stored in database 240 prior to initiating Stage I of Process II. Preferably, these documents are created when an account is created for the VC Firm. These may be from existing templates or forms prepared by the VC fund. These documents are retrieved and the details of the stock certificates selected by the VC fund are used to update the documents. The updated documents are then displayed. The VC fund then executes these documents. A distribution action is now created. A new sub-record is created in database 240 for each of the partners of the VC fund and this sub-record is updated with the details of the distribution that are relevant to each limited partner. These details include the name and number of the stock, the legend information, the delegending steps, the relevant documents and other information that the VC fund may specify. A pending action record is created for intervention by each limited partner. Automated notifications are sent to the Legal Counsel of the Issuer, the Transfer Agent of the Issuer, all partners of the VC fund and to the Broker that may have been optionally selected by the VC fund. Distribution documents are optionally printed as well. The distribution action is released to Stage II.

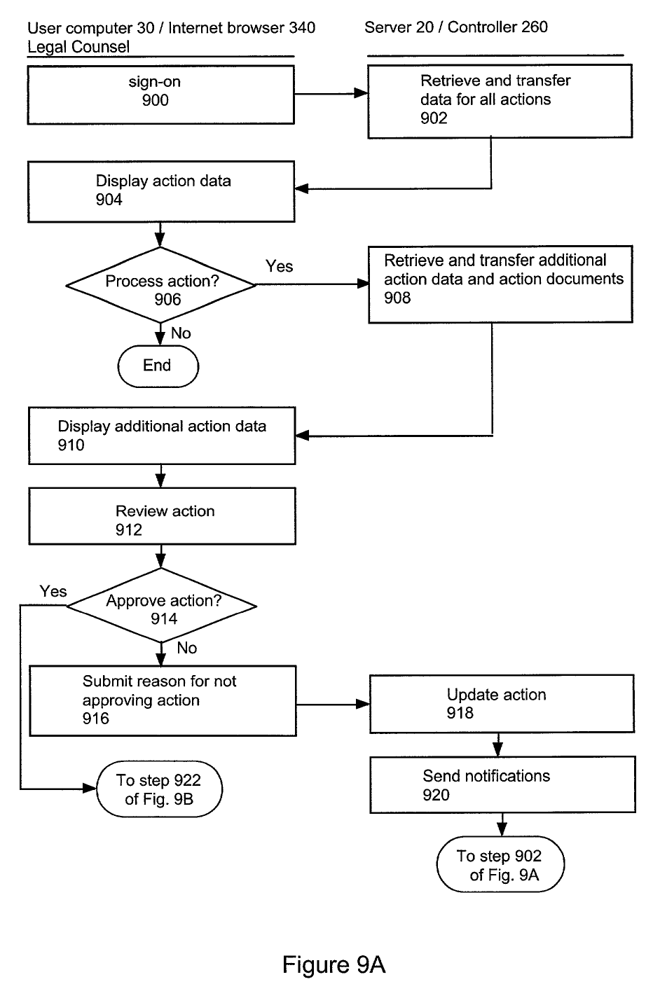

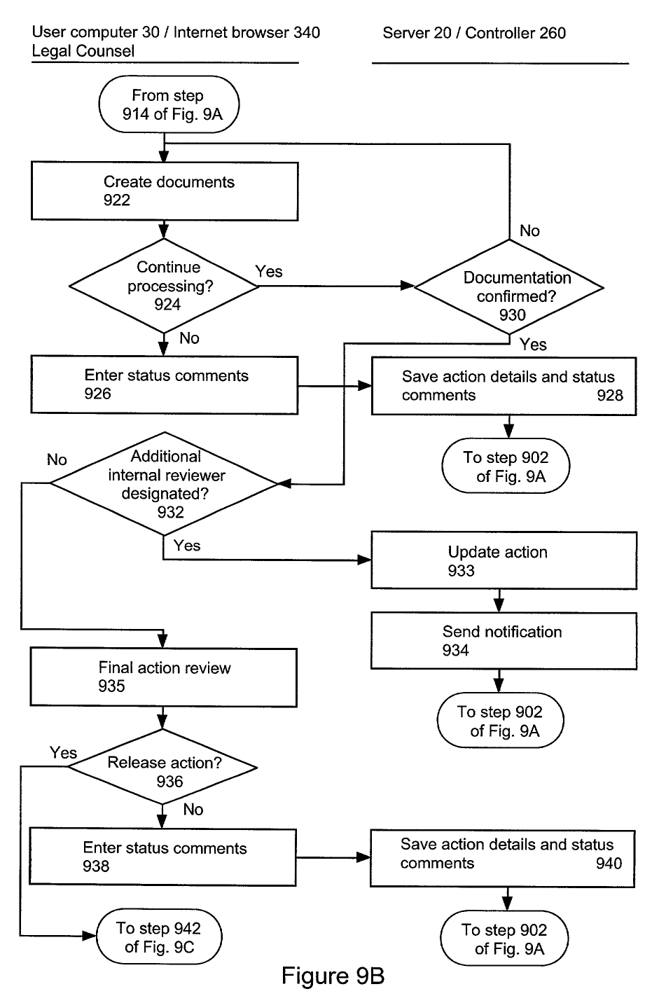

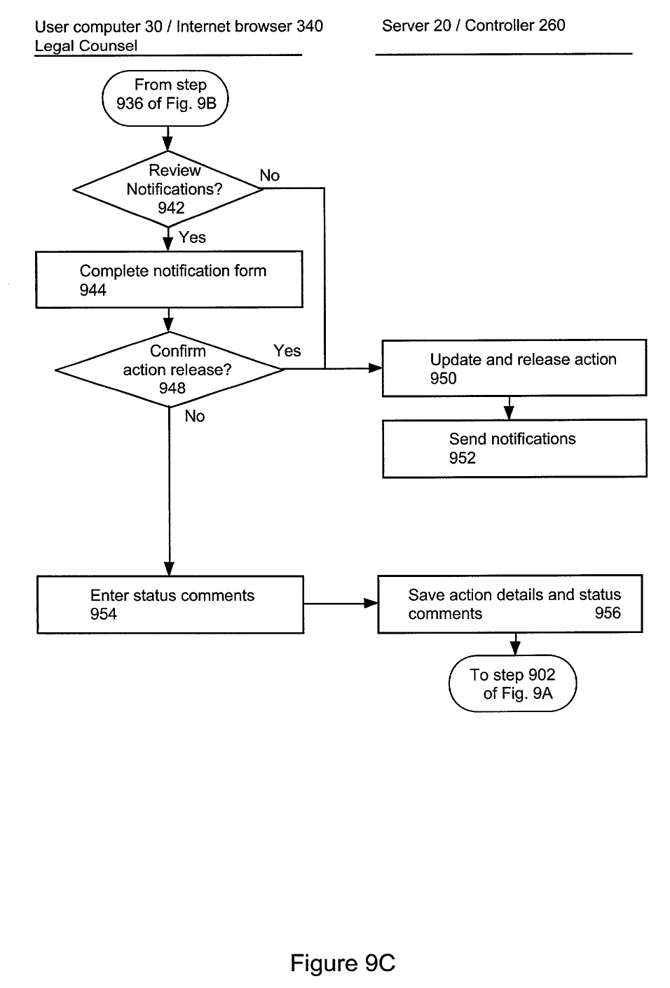

FIGS. 9A-9C are a process diagram of Stage II of Process II, which describes the actions taken by the Legal Counsel of the Issuer of the stock distributed by the VC fund and the events triggered by these actions. The Legal Counsel of the Issuer signs onto Server 20 and selects the action from a menu of actions pending intervention by the Legal Counsel. The Legal Counsel views the distribution documents and either approves or disapproves the action. If the action is disapproved, the distribution action is suspended with an appropriate reason and the requirements for approval stored in database 240. Automatic notifications are sent to all entities notified at the completion of Stage I. If the action is approved, then the relevant documents are retrieved from database 240, updated with the details relevant to the specific distribution action that is being approved. The resulting documents are then displayed. The Legal Counsel executes these documents. The documents executed by the Legal Counsel are then stored in database 240 and optionally printed if executed on-line. Automatic notifications are sent to the Transfer Agent and all the other entities notified at the completion of Stage I. The action is released to Stage III.

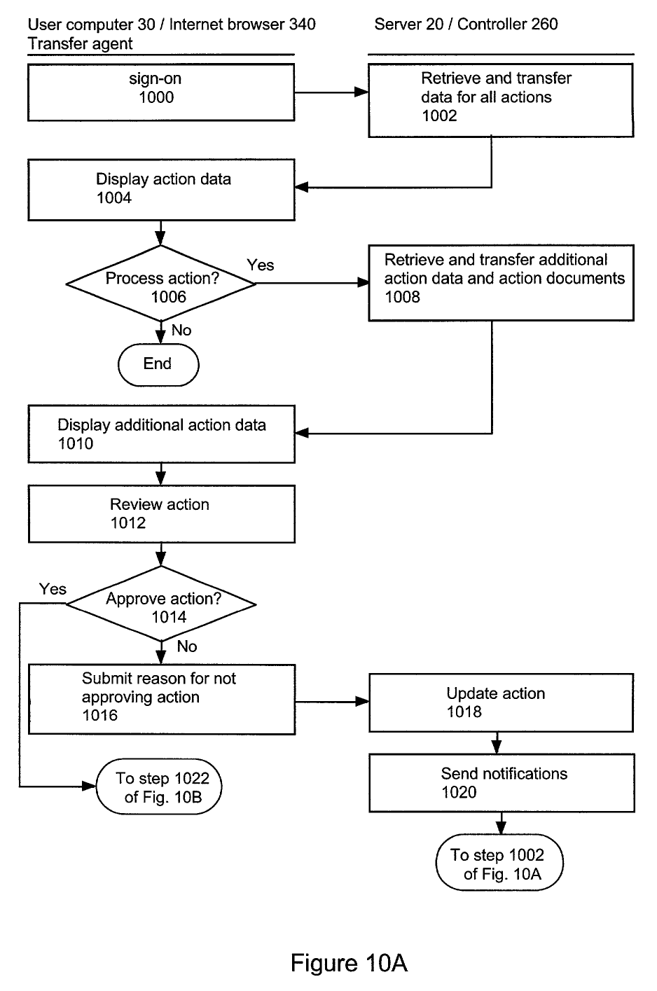

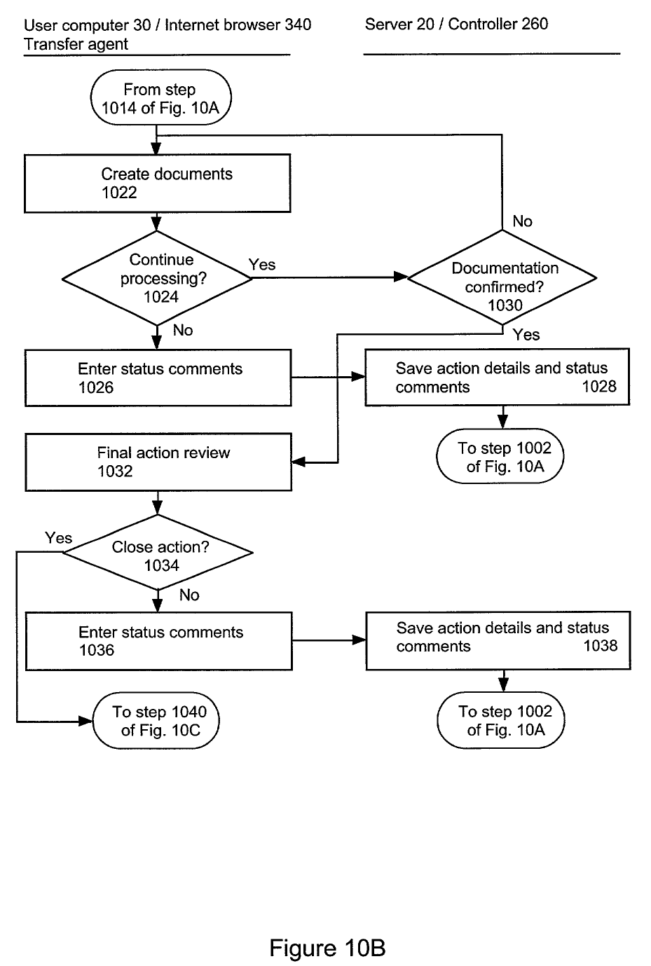

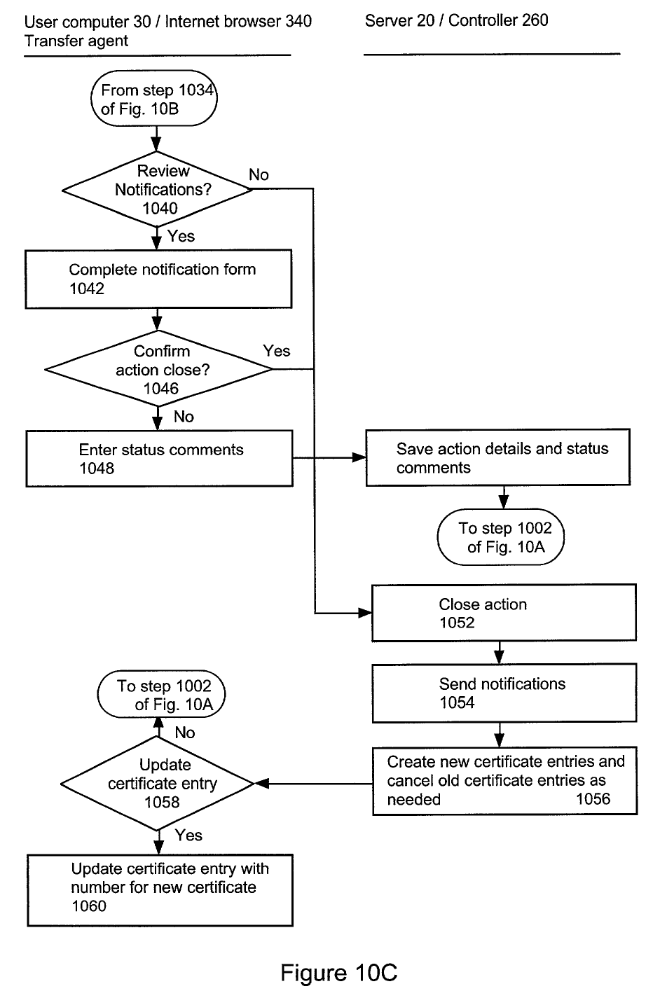

FIGS. 10A-10C are a process diagram of Stage III of Process II, which describes the actions taken by a Transfer Agent of the Issuer and the events triggered by these actions including the successful completion of Process II. The Transfer Agent signs onto Server 20 and selects an action from a menu of actions pending intervention by the Transfer Agent. The Transfer Agent can suspend or close the action. If the action is suspended, then the specific requirements that would be needed to accept the action are stated by the Transfer Agent and automatic notifications are sent to the VC fund and the Legal Counsel and all other entities notified at the completion of Stage III. If the action is closed, the Transfer Agent specifies the details of the steps performed by the Transfer Agent. These details may include stock certificate numbers and data concerning new stock certificates created in the name of each limited partner. The holdings records and the pending action records of the partners are updated. Automatic notifications are sent to all the entities notified at the completion of Stage II. The action is now successfully completed and closed.

The general nature of the present invention has now been disclosed. Attention now turns to a more detailed discussion of the processing steps, found in a preferred embodiment of the present invention.

In particular, FIG. 4A illustrates processing steps executed when a Holder signs on to server 20 through the use of user computer 30 to initiate, continue, complete, or suspend Stage I of Process I. Upon accessing Website 230 using Internet browser 340 (e.g., Microsoft Internet Explorer, Netscape Navigator), a Holder signs on to server 20 using a user name and password combination (step 400). After the sign-on is completed, controller 260 determines if the Holder has any pending actions (e.g., a pending action to delegend one or more stock certificates) by reference to action records maintained in database 240 as described above (step 402). If so, processing step 456 of FIG. 4D, as described below, is executed. If not, controller 260 retrieves and transfers holdings data of the Holder from database 240 to user computer 30 (step 404). In particular, controller 260 accesses database 240 to locate each Holder sub-record for each of the individual holdings of restricted stock owned by the Holder. Persons skilled in the art will recognize that any number of techniques are capable of performing a keyword search against one or more databases.

This information is then displayed by Internet browser 360 on i/o device 320 (step 406). The holdings data displayed is preferably grouped by each stock certificate held by the Holder. Additionally, the displayed holdings data preferably includes the Issuer of the stock certificate, the fund to which the stock certificate belongs, the stock certificate number, the acquisition date of the stock certificate, the number of shares issued, the number of remaining shares (the number of shares issued minus the number of shares already processed), and the process type (e.g., Rule 144, Rule 701, Rule 144K).

The Holder then has the option of creating an action. The actions available to the Holder are the delegending and sale of, or just the delegending of, a specified number of shares from one or more restricted stock certificates. If the Holder opts to delegend and sell a specified number of shares from one or more restricted stock certificates, a Broker or other Holder representative is generally involved in the process. If the Holder opts only to delegend a specified number of shares from one or more restricted stock certificates, a Broker is typically not involved in the process.

As already indicated, the Holder can opt to create an action involving some or all of the shares from one or more stock certificates (in which case, the entry for the stock certificate with only a portion of the shares selected is adjusted accordingly to reflect a reduced number of shares remaining). However, the Holder cannot, in a single action, include stock certificates of different process types nor stock certificates issued by different Issuers. In other words, all stock certificates involved in a single action have unity of process type and Issuer.

If the Holder does not create an action (step 408-No), the Holder eventually signs off of server 20.

If however, the Holder creates an action (step 408-Yes), an action-ID is generated by controller 260 (step 409) and action verification data is displayed to the Holder (step 410). The action-ID is a unique identifier used to reference the newly created action throughout the various stages involved action. The displayed information preferably includes the selected action, the Issuer of each stock certificate selected, the stock certificate number of each stock certificate selected, and the total number of shares remaining for each stock certificate selected. The action-ID created by controller 260 is preferably displayed as well. Furthermore, the Holder is presented with a standard text box for entry of the number of shares to be acted upon for each stock certificate selected. The displayed information also preferably includes additional information for the purpose of avoiding errors or delays in the processing of the action. For example, the displayed information includes a reminder about the regulatory and legal responsibilities imposed on the Holder during this process.

Upon entering the desired number of shares and reviewing the displayed information, the Holder has the option to continue processing the action (i.e., verifying the action) or suspending and saving the action (step 412).

If the Holder suspends and saves the action (step 412-No), the Holder is prompted to enter status comments regarding the action (step 414). Status comments can include for example, the reason suspending and saving the action or instructions for later continuance of action processing. Controller 260 then saves the action details (the selected action, the Issuer of each stock certificate selected, the stock certificate number of each stock certificate selected, and the total number of shares selected from each selected stock certificate) and status comments in database 240 (step 416). Or more specifically, in an action record as described above. Action status data, as described below (beginning with reference to step 456 of FIG. 4D), is then displayed for the Holder.

If the Holder continues processing the action (step 412-Yes), the Holder is given the opportunity to create documents necessary to the completion of this stage of the action (step 422, FIG. 4B). Currently, only a seller's representation letter is required for most actions. A seller's representation letter includes various representations about how the stock certificates were acquired, limitations placed on the transference of the stock certificates, and whether the Holder is affiliated with the Issuer of the stock certificates. Additionally, a Rule 144 Form is required for Rule 144 process type actions. Currently, this document provides notice of a proposed sale of securities pursuant to Rule 144 under the Securities Act of 1933. However, the document requirements are dictated by SEC regulations and the preferences of the various entities involved in the processing of the action. Accordingly, embodiments of the invention are designed with enough flexibility to modify the document requirements for each stage of the action as needed. Additionally, the Holder can retrieve document templates from database 240 using Internet browser 340 and web pages from Website 230 for purpose of creating documents. As noted above, documents and other information is maintained in a Holder record in database 240. These document templates are preferably created when an account is created for the Holder. Essentially, these documents include any information deemed by the Holder, in accordance with SEC regulations, to be important. The Holder also has the option of importing documents or document templates from a different source (e.g., the memory of Holder computer 20, or any other source accessible by user computer 30). In either case, the Holder can view and edit the documents using a compatible word processor (e.g., Microsoft Word, Word Perfect, Adobe Acrobat). Additionally, the Holder can selectively ignore any document requirement imposed on the Holder. If so, the Holder is preferably prompted to enter an explanation in a dialog box. This information is then accessible by subsequent entities processing the action concerned about the absence of one or more documents. Generally, this occurs when a Holder, or other party at a different stage of the action, exchanges documents with another entity in the process without using the present invention. Although this isn't recommended, embodiments of the invention are designed with enough flexibility to allow for this possibility.

At any time after the Holder begins creating documents, the Holder can suspend and save the action as described above with reference to steps 412-No, 414, and 416 (steps 424-No, 426, and 428 respectively).

The Holder can also continue the action (step 424-Yes). If so, controller 260 confirms that each required document is created or selectively ignored (step 430). If not, the Holder is returned to the previous step in order to complete creating documents (step 430-No). If on the other hand, controller 260 confirms that each required document is created or selectively ignored (step 430-Yes), the Holder is given an opportunity to review the action (step 432). During this review, the Holder preferably has the option of entering Broker identification information (e.g., Brokerage firm, Broker name, assistant name, e-mail address, phone number, fax number, etc.). Additionally, the Holder preferably has the option of entering identification information (e.g., agent firm, agent name, assistant name, e-mail address, phone number, fax number, etc.) of a person or entity responsible for filing forms required by the SEC or other agencies. Finally, the Holder can elect to review an automated notifications list upon completing the review and continuing to the next step of action processing.

At any time after the process of reviewing the action begins, the Holder can save and suspend the action as described above with reference to steps step 412-No, 414, and 416 (steps 434-No, 436, and 438 respectively).

If the Holder continues processing the action (step 434-Yes) and has elected to review the automated notifications list (step 440-Yes, FIG. 4C), the Holder is presented with a list of persons or entities notified when the Holder finally releases the action to the next stage of the process (step 442). The list includes identification information (e.g., firm, name, assistant name, e-mail address, phone number, fax number, etc.). The list is preferably initialized with data maintained in database 240. As noted above, the Holder record maintained in database 240 includes sub-records with links to stock certificate Issuers, Brokers, etc. These links are utilized by controller 260 to obtain updated contact information for each of these entities. Additionally, the Holder can when the account on server 20 is created for the Holder, or any time thereafter, specify persons or entities to be included in the list of person by default. This information is maintained in the Holder record and used to initialize the automated notifications list. Furthermore, the Holder is able to edit this list as needed.

At any time after the process of reviewing the automated notifications list begins, the Holder can suspend and save the action as described above with reference to steps step 412-No, 414, and 416 (steps 446-No, 452, and 454 respectively).

If the Holder continues processing the action after reviewing the automated notifications (step 446-Yes) or if the Holder did not elect to review the automated notifications after reviewing the action (step 434-Yes, step 440-No), the status of the action is updated (i.e., the action is released to the next stage) (step 448) and the notifications are sent to the defined recipients (step 450). The notifications alert the other parties about the release of the action to the next stage by the Holder. More specifically, the person or persons responsible for the completion of the next stage can access server 20 in order to execute their required steps. Updating the action status includes storing an indication as to which stage of the process the action is in. For example, the Holder has just released the action to Stage II of Process I. Generally, this means that a Broker selected by the Holder is now the party responsible for processing the action. Accordingly, the action record includes an entry indicating that the Broker is currently responsible for the action. Generally, after the action is released to the next stage, the Holder signs off of server 20 and exits the system. However, the Holder can also return to view the holdings data (as described above with reference to step 404) or view data related to actions already in progress (as described below with reference to step 456).

Controller 260 retrieves from database 240 and transfers to Holder computer 20 data relating to pending actions (i.e., actions that the Holder has initiated but have not been completed) (step 456, FIG. 4D). The data is then displayed to the Holder (step 458). For each action, an entry including the action-ID, action status, stock certificate fund, stock certificate numbers, number of shares included in the action, Brokerage firm (if entered), stock certificate Issuer, Legal Counsel (if entered), and Transfer Agent (if entered) is displayed. If the Holder suspended and saved the action before releasing it to the next stage, an entry for that action is included in the list of pending actions. In that case, the status of the action reflects that the Holder is still the responsible party for that particular action. If on the other hand, the Holder has already released the action to the next stage, the status displayed is indicative of the current stage of processing (e.g., Broker, Issuer, Legal Counsel, or Transfer Agent).

The Holder can view details of a listed action or sign-off of server 20 (step 460). If the Holder chooses to view details of a listed action (step 460-Yes), controller 260 retrieves and transfers additional action data to user computer 30 (step 462), which is displayed for the Holder (step 464). This data includes for example, status comments entered by the Holder or any other party that has processed the action. The Holder can also view documents created by the Holder and other entities during later stages of action processing. The Holder can also continue processing an action that has not been released to the next stage by the Holder (step 468-Yes) or return to the displayed list of pending actions (step 468-No). If the Holder continues processing an action (step 468-Yes), controller 260 returns the Holder to the step at which the Holder elected to suspend and save the action (step 470). For example, if the Holder elected to suspend and save the action while reviewing the action (step 432), the Holder is returned, by controller 260, to step 432 as described above. Basically, this is accomplished by displaying the data and options that were available when the Holder last accessed step 432.

The next stage of the process is Stage II of Process I and is generally completed by a Brokerage firm selected by the Holder. As noted above, a Brokerage firm is not needed if the Holder elects only to delegend shares of a stock certificate rather than delegend and sell shares of a stock certificate. Additionally, the Issuer could actually complete what is described as Stage III of Process I before Stage II of Process I is completed. The reason is that the Broker and Issuer are concerned primarily with the activities of the Holder rather than each other. More specifically, the work completed by the Broker and Issuer is generally not interdependent. The processing steps executed during this stage are illustrated in FIGS. 5A-5C.

This stage begins with the Broker signing on to server 20 (step 500, FIG. 5A). The Broker is also be prompted to access server 20 via e-mail, or other technique, when the Holder releases the action to Stage II. After the Broker is signed on, controller 260 retrieves from database 240 and transfers to user computer 30 data relating to pending actions that require processing by the Broker (step 502). The data is then displayed to the Broker (step 504). This data encompasses actions that were partially processed by the Broker and actions that have just entered or re-entered the stage of the Broker. For each action, an entry including the action-ID, action status, Holder, stock certificate fund, stock certificate numbers, number of shares included in the action, Issuer, Legal Counsel, and Transfer Agent is displayed.

When a Broker is ready to process the action (step 506-Yes), the Broker is given the opportunity to create documents necessary to the completion of the action (step 518). In particular, a Broker typically includes a Broker's representation letter. In this document, the Broker usually makes representations such as conducting the sale pursuant to “manner of sale restrictions” rules promulgated by the SEC. For example, some process types required advertisement restrictions for stock certificate sales. Additionally, S-3 prospectus delivery is required for some process types. Furthermore, 144, 144k, and 145 process types have sales volume restrictions.

For each required document, and any optional documentation, the Broker can retrieve a document template from database 240 using Internet browser 340 and web pages from Website 230. The Broker also has the option of importing a document from a different source. In either case, the Broker can view and edit the documents using a compatible word processor. Additionally, the Broker can ignore any required documents. If so, the Broker is preferably prompted to enter an explanation in a dialog box. This information is then accessible by subsequent users concerned about the absence of a document.

Any time after the process of creating documents begins, the Broker can suspend and save the action (step 520-No). The Broker is then prompted to enter status comments (step 526), which are saved with the action details in database 240 (step 522). Controller 260 then retrieves and transfers to user computer 30 data for all pending actions (step 502), which is displayed for the Broker (step 504) as described above.

The Broker can also choose to continue processing the action (step 520-Yes). If so, controller 260 confirms that each required document is created or selectively ignored (step 526). If not, the Broker is returned to the step of creating documents (step 526-No). If on the other hand, controller 260 confirms that each required document is created or selectively ignored (step 526-Yes), processing of the action continues.

The Broker is also given the opportunity to conduct a review of the action (step 530). Essentially, action data is displayed for the Broker again before the action is released by the Broker to the next stage. The Broker can also elect to review an automated notifications list upon completing the review and continuing to the next step of action processing.

Any time after the review begins, the Broker can suspend and save the action (step 532-No, FIG. 5B). The Broker is then prompted to enter status comments (step 534), which are saved with the action details in database 240 (step 536). Controller 260 then retrieves and transfers to user computer 30 data for all pending actions (step 502), which is displayed for the Broker (step 504) as described above.

If the Broker chooses to continue processing the action (step 532-Yes, FIG. 5B) and has elected to review the automated notifications list (step 538-Yes), the Broker is presented with a list of persons or entities that are notified when the Broker finally releases the action to the next stage (step 540). The list includes identification information (e.g., firm, name, assistant name, e-mail address, phone number, fax number, etc.). The list is preferably initialized with data maintained in database 240 and updated by the Holder in step 442.

Any time after the process of reviewing the automated notifications list begins, the Broker can suspend and save the action (step 544-No). If the Broker does so, the Broker is prompted to enter status comments (step 550), which are saved with action details in database 240 (step 552). Controller 260 then retrieves and transfers to user computer 30 data for all pending actions (step 502), which is displayed for the Broker (step 504) as described above.

If the Broker continues processing the action after reviewing the automated notifications (step 544-Yes) or if the Broker did not elect to review the automated notifications after reviewing the action (step 532-Yes, step 544-No), the status of the action is updated (i.e., the action is released to the next stage) (step 546) and the notifications are sent to the defined recipients (step 548).

The next stage of the process is Stage III of Process I and is generally completed by the Issuer of the selected one or more stock certificates involved in the action. These processing steps are illustrated in FIGS. 6A-6C.

This stage begins with the Issuer signing on to server 20 (step 600, FIG. 6A). The Issuer is also be prompted to access server 20 via e-mail, or other technique, when the Holder or Broker releases the action to Stage III. After the Issuer is signed on, controller 260 retrieves from database 240 and transfers to user computer 30 data relating to pending actions that require processing by the Issuer (step 602). The data is then displayed to the Issuer (step 604). This data encompasses actions that are only partially processed by the Issuer and actions that have just entered or re-entered (i.e., not approved by subsequent stages) this stage. For each action, an entry including the action-ID, action status, Holder, stock certificate fund, stock certificate numbers, number of shares included in the action, Brokerage firm, stock certificate Issuer, Legal Counsel, and Transfer Agent is displayed.

Upon viewing the action data, the Issuer can process an action (step 606-Yes) or sign-off of server 20 (step 606-No). If the Issuer chooses to process an action (step 606-Yes), controller 260 retrieves and transfers additional action data and action documents to user computer 30 (step 608). The additional action data is displayed for the Issuer (step 610). This additional action data includes for example, status comments submitted during any stage and reasons for not approving the action during subsequent stages.

The Issuer then has then has the option to review the work completed for the action in earlier stages (step 612). Essentially, this involves reviewing the documentation completed in earlier stages. For example, the documents typically included a seller's representation letter, Rule 144 Form, and Broker's representation letter. However, the Issuer need not review this documentation since the Issuer typically doesn't issue a representation letter. On the other hand, certain events preclude some Holders from selling stock certificates and the Issuer may want to monitor the sale of its stock certificate in conjunction with these events. Such events occur when, for example, a Holder is also a “corporate insider” of the Issuer and the Issuer will soon issue, or has recently issued, and announcement that adversely or positively affects the price of the selected stock certificate. Another example, is an agreement, not reflected on the face of the selected stock certificate, between the Holder—who is also a “corporate insider” of the Issuer—and the Issuer to not sell the selected stock certificate during the current time period. Access to these documents is provided on the display by, for example, a hyperlink. Once selected by the Issuer, a compatible word processor is used to display the contents of the document. After reviewing the action, the Issuer has the option to approve the steps taken for the action prior to Stage III (step 614). If the Issuer does not approve the action (step 614-No), controller 260 prompts the Issuer to submit a reason for not approving the action (step 616). Controller 260 then updates the status of the action (step 618), which also includes saving the reasons for not approving the action in database 240, and sending notifications to the person or entities notified in step 450 and 548 (step 620). Controller 260 then retrieves and transfers to user computer 30 data for all actions pending Issuer intervention (step 602), which is displayed for the Issuer (step 604) as described above.

If the Issuer approves the action (step 614-Yes), the Issuer is given the opportunity to create documents necessary to the completion of the action (step 622, FIG. 6B). To complete this step of the process, the Issuer can retrieve document templates from database 240 using Internet browser 340 and web pages from Website 230. The Issuer also has the option of importing a document or document template from a different source. In either case, the Issuer can view and edit the documents using a compatible word processor. Additionally, the Issuer can choose to ignore the document requirements. If so, the Issuer is preferably prompted to enter an explanation in a dialog box. This information is then accessible by other users concerned about the absence of one or more documents.

The Issuer is also preferably given, at this step of the process, the option of specifying the next person within the Issuer entity to review the action. Often, more than one person must review an action before it is released to the next stage. For example, an Issuer might have a junior employee review the action before a more senior employee provides a final review of the action. The present invention is designed to allow the Issuer to specify in advance the names and order of the reviewers within the organization. Thus, when an action is released to the Issuer stage, a designated person is given the task of reviewing the action first. Further, at this step of the process, controller 260 can automatically include the name and email address of the next person within the Issuer entity to review the action. If the final reviewer has been reached, no such information is included. Additionally, the Issuer has the option of altering this information as needed (e.g., change the next person within Issuer entity to review the action).

At any time after beginning the process of creating documents, the Issuer can suspend and save the action (step 624-No). The Issuer is then prompted to enter status comments (step 626), which are saved with the action details in database 240 (step 628). Controller 260 then retrieves and transfers to user computer 30 data for all pending actions (step 602), which is displayed for the Issuer (step 604) as described above.

The Issuer can also continue processing the action (step 624-Yes). If so, controller 260 confirms that each required document has been created or selectively ignored by the Issuer (step 630). If not, the Issuer is returned to the step of creating documents (step 630-No). If on the other hand, controller 260 confirms that each required document is created or selectively ignored (step 630-Yes), processing of the action continues.

The next step depends upon whether an additional person within the Issuer entity is specified in step 622 (step 632). If so (step 632-Yes), controller 260 updates the action status (step 633) and sends a notification to the person designated in step 622 (step 634). In a preferred embodiment of the invention, only the person designated in step 622 is notified so that the Issuer can maintain a certain amount of internal autonomy. Thus, persons outside of the Issuer organization know only that the Issuer entity is still processing the action, but do not know with certainty the specific individual currently responsible for the action. Controller 260 then retrieves and transfers to user computer 30 data for all pending actions (step 602), which is displayed for the Issuer (step 604) as described above.

If an additional person is not designated to review the action in step 622, the Issuer is given the opportunity to conduct a final review of the action (step 635). Essentially, action data is displayed for the Issuer again before the action is released by the Issuer to the next stage. The Issuer can also elect to review an automated notifications list upon completing the review and continuing the action processing.

Any time after the final review begins, the Issuer can suspend and save the action (step 636-No). The Issuer is then prompted to enter status comments (step 638), which are saved with the action details in database 240 (step 640). Controller 260 then retrieves and transfers to user computer 30 data for all pending actions (step 602), which is displayed for the Issuer (step 604) as described above.

If the Issuer chooses to continue processing the action (step 636-Yes) and has elected to review the automated notifications list (step 642-Yes, FIG. 6C), the Issuer is presented with a list of persons or entities that are notified when the Issuer finally releases the action to the next stage of the action (step 644). The list includes identification information (e.g., firm, name, assistant name, e-mail address, phone number, fax number, etc.). The list is preferably initialized with data maintained in database 240 and updated by the Holder in step 442 and the Broker in step 540.

Any time after the process of reviewing the automated notifications list begins, the Issuer can suspend and save the action (step 648-No). If the Issuer does so, the Issuer is prompted to enter status comments (step 654), which are saved with action details in database 240 (step 656). Controller 260 then retrieves and transfers to user computer 30 data for all pending actions (step 602), which is displayed for the Issuer (step 604) as described above.

If the Issuer chooses to continue processing the action after reviewing the automated notifications (step 648-Yes) or if the Issuer did not elect to review the automated notifications after reviewing the action (step 636-Yes, step 642-No), the status of the action is updated (i.e., the action is released to the next stage) (step 650) and the notifications are sent to the defined recipients (step 652).

The next stage of the process is Stage IV of Process I and is generally completed by Legal Counsel working for the Issuer. Generally, smaller Issuers rely upon law firms to provide an opinion letter, which states that the action conforms to SEC regulations. However, larger Issuers often maintain attorneys on staff, so hiring an outside law firm is not required. Nevertheless, an opinion letter is still required, so an attorney, whether from the staff of the Issuer or from an outside law firm, must complete this stage of the process. To deal with either situation effectively and seamlessly, the present invention preferably does not differentiate between the two. The attorney responsible for the letter and that attorney's, partners, associates, and assistants are designated by the Issuer as being responsible for drafting an opinion letter. It just so happens that at times, these people are actually staff members of the Issuer.

Additionally, the processing steps executed during the stage completed by the attorney are identical to the processing steps completed by the Issuer as described in steps 600-656 of FIGS. 6A-6C and won't be repeated now in their entirety. However, some steps are substantively different, and those steps will be discussed.

In step 612, the Legal Counsel is given the opportunity to review the documentation produced in earlier stages. Since the Legal Counsel issues an opinion letter, as described below, the review conducted by the Legal Counsel is much more thorough and exacting than in other stages of the action. For example, the Legal Counsel confirms that representations made by the Holder and the Broker are accurate (e.g., adequacy of the representations, and that the trade date matches the date of the seller's representation letter), that the action is in compliance with applicable regulations, and that all necessary documents are created or accounted for and valid (e.g., the Rule 144 Form information such as sales by the Holder within the last three months is disclosed therein).

If the Legal Counsel does not approve of the action (step 614), the Legal Counsel submits one or more reasons for not doing so (step 616). The Legal Counsel can also specify a specific stage to which the action is sent. For example, if the Legal Counsel determines that the Holder made a mistake, the Legal Counsel can send the action back to Stage I. Regardless of which specific stage the action is sent, notifications are sent to the entities notified when Stage II is completed (step 620).

Another critical distinction between Stage III and Stage IV is step 622. In this step, Legal Counsel creates, among other documents, a legal opinion. The legal opinion directs the Transfer Agent to process the action.

The next and final stage of the process is Stage V of Process I and is generally completed by a Transfer Agent. The Transfer Agent actually exchanges unrestricted shares for the restricted shares selected by the Holder. In so doing, the Transfer Agent relies, in particular, on the opinion letter drafted by the Legal Counsel. Without this letter, a Transfer Agent will not exchange unrestricted shares for restricted shares. The processing steps executed during the stage completed by the Transfer Agent are illustrated in FIGS. 7A-7C.

This stage begins with the Transfer Agent signing on to server 20 (step 700, FIG. 7A). After the Transfer Agent is signed on, controller 260 retrieves from database 240 and transfers to user computer 30 data relating to pending actions that require processing by the Transfer Agent (step 702). The data is then displayed to the Transfer Agent (step 704). This data encompasses actions that were partially processed by the Transfer Agent and actions that have just entered or re-entered Stage V. For each action, an entry including the action-ID, action status, Holder, stock certificate fund, stock certificate numbers, number of shares included in the action, Brokerage firm, stock certificate Issuer, Legal Counsel, and Transfer Agent is displayed.

Upon viewing the action data, the Transfer Agent can process an action (step 706-Yes) or sign-off of server 20 (step 706-No). When the Transfer Agent chooses to process an action (step 706-Yes), controller 260 retrieves and transfers additional action data and action documents to user computer 30 (step 708). The additional action data is displayed for the Transfer Agent (step 710).

The Transfer Agent then has then has the option to review the work completed for the action (step 712). Essentially, this involves reviewing the documentation completed in earlier stages. Typically, a Transfer Agent is only concerned about the legal opinion. Access to the documents is provided on the display by, for example, a hyperlink. Once selected, the Transfer Agent selects a document, and a compatible word processor is used to display the contents of the document. Additionally, the Transfer Agent requires the original selected restricted stock certificates (with each signed by the Holder) or a Stock Power and a Medallion or Bank Guaranty to guarantee the signatures. Furthermore, corporate Holders are also required to deliver a corporate stock transfer form to the Transfer Agent.

After reviewing the action, the Transfer Agent has the option to approve the action (step 714). If the Transfer Agent does not approve the action (step 714-No), controller 260 prompts the Transfer Agent to submit a reason for not approving the action (step 716). Controller 260 then updates the status of the action (718), which includes saving the reasons for not approving the action in database 240, and sending notifications to the person or entities notified in earlier stages (step 720). Controller 260 then retrieves and transfers to user computer 30 data for all pending actions (step 702), which is displayed for the Transfer Agent (step 704) as described above.

If the Transfer Agent approves the action (step 714-Yes), the Transfer Agent is given the opportunity to create documents necessary to the completion of the action (step 722, FIG. 7B). For each of document, the Transfer Agent can retrieve a document template from database 240 import the document from a different source. In either case, the Transfer Agent can view and edit the documents using a compatible word processor. Additionally, the Transfer Agent can ignore document requirements. If so, the Transfer Agent is preferably prompted to enter an explanation in a dialog box. This information is then accessible by subsequent users concerned about the absence of a document.

At any time after the process of creating documents begins, the Transfer Agent can suspend and save the action (step 724-No). The Transfer Agent is then prompted to enter status comments (step 726), which are saved with the action details in database 240 (step 728). Controller 260 then retrieves and transfers to user computer 30 data for all pending actions (step 702), which is displayed for the Transfer Agent (step 704) as described above.

The Transfer Agent can also choose to continue the action (step 724-Yes). If so, controller 260 confirms that each required document is created or selectively ignored (step 730). If not, the Transfer Agent is returned to the step of creating documents (step 730-No). If on the other hand, controller 260 confirms that each required document is created or selectively ignored (step 730-Yes), processing of the action continues.

The Transfer Agent is then given the opportunity to conduct a final review the action (step 732). Essentially, action data is displayed for the Transfer Agent again before the action is released by the Transfer Agent to the next stage. The Transfer Agent can also elect to review an automated notifications list upon completing the review and continuing to the next step of action processing.

Any time after the final review begins, the Transfer Agent can suspend and save the action (step 734-No). The Transfer Agent is then prompted to enter status comments (step 736), which are saved with the action details in database 240 (step 738). Controller 260 then retrieves and transfers to user computer 30 data for all pending actions (step 702), which is displayed for the Transfer Agent (step 704) as described above.

If the Transfer Agent chooses instead to close the action (step 734-Yes) and has elected to review the automated notifications list (step 740-Yes, FIG. 7C), the Transfer Agent is presented with a list of persons or entities that are notified when the Transfer Agent finally releases the action to the next stage of action (step 742). The list includes identification information (e.g., firm, name, assistant name, e-mail address, phone number, fax number, etc.). The list is preferably initialized with data maintained in database 240 and updated by the Holder in step 442 of FIG. 4C, the Issuer and Legal Counsel in step 654 of FIG. 6C, and the Broker in step 540 of FIG. 5C.

At any time after the process of reviewing the automated notifications list begins, the Transfer Agent can suspend and save the action (step 746-No). If the Transfer Agent does so, the Transfer Agent is prompted to enter status comments (step 748), which are saved with action details in database 240 (step 750). Controller 260 then retrieves and transfers to user computer 30 data for all pending actions (step 702), which is displayed for the Transfer Agent (step 704) as described above.

If the Transfer Agent chooses to close the action after reviewing the automated notifications (step 746-Yes) or if the Transfer Agent did not elect to review the automated notifications after reviewing the action (step 734-Yes, step 740-No), the status of the action is updated (i.e., the action is closed) (step 752) and the notifications are sent to the defined recipients (step 754).

As noted above, the Holder may elect to delegend only some of the shares included in a selected restricted stock certificate. When this occurs, the selected restricted stock certificate entry in the holdings data is modified to reflect the reduced number of shares remaining. This prevents a Holder from attempting to delegend shares no longer available. When the delegending process is closed by a Transfer Agent, controller 260 or the Transfer Agent closing the delegending process creates a new entry in the holdings data to represent a newly created restricted stock certificate that includes the remaining shares of the selected restricted stock certificate and deletes the selected restricted stock certificate entry (step 756). This process is required because the Transfer Agent must create a new restricted stock certificate and destroy the previous stock certificate. All of the data from the previous restricted stock certificate entry is incorporated in the new entry. One exception to this is that the number of shares issued data and the number of shares remaining data is set to reflect the reduced number of shares available. Additional data that is changed includes the date of creation and the stock certificate number.

The Transfer Agent also issues one or more unrestricted stock certificates reflecting shares of each restricted stock certificates selected for delegending. If as described above, only a portion of one or more selected restricted stock certificates is part of the delegending process, the Transfer Agent also issues one or more restricted stock certificates having a proportionately reduced number of shares.

The Transfer Agent is also given the option (step 758-Yes) to update the stock certificate entries created for each partner as a result of the distribution action (step 760). If the Transfer Agent declines, Controller 260 then retrieves and transfers to user computer 30 data for all pending actions (step 702), which is displayed for the Transfer Agent (step 704) as described above.

As described above, a VC fund holds stock certificates that are distributed to the partners of the VC fund. Generally, the distribution process involves breaking down a stock certificate according to the ownership position of each limited partner. The positions held by each partner may or may not be equal. Either way, a distribution table controls the distribution process as will be described below.

Often times, the stock certificates distributed are restricted. Accordingly, shares of stock certificates distributed by a VC fund may or may not be restricted. When the stock certificates selected for distribution are restricted, the resultant stock certificates distributed to the partners of the VC fund are restricted as well. In such case, each partner receiving a distribution of restricted stock certificates typically uses the delegending process described in detail with reference to FIG. 4A-10C to delegend and sell the restricted stock certificates. Generally, the sale takes place concurrently or a short while after the distribution is completed. Accordingly, in this invention, documentation utilized in the delegending process described in detail with reference to FIG. 4A-10C is often prepared during the distribution process.

FIGS. 8A-8D illustrate the processing steps executed in the first stage of the distribution process—Stage I of Process II. Stage I begins when a representative of a VC fund (“VC fund”) signs on to server 20 through the use of user computer 30. More specifically, the VC fund accesses Website 230 using Internet browser 340 and signs on to server 20 using a user name and password combination (step 800). After the sign-on is completed, controller 260 determines if the VC fund has any pending actions (e.g., a pending action to distribute a stock certificate held by the VC fund) by reference to records of the VC fund maintained in database 240 (step 802). If so, processing step 862 of FIG. 8D, as described below, is executed. If not, controller 260 retrieves and transfers holdings data of the VC fund from database 240 to user computer 30 (step 804).

This information is then displayed by Internet browser 360 on i/o device 320 (step 806). The holdings data displayed is preferably grouped by each stock certificate held by the VC fund. Additionally, the displayed holdings data preferably includes the Issuer of the stock certificate, the fund to which the stock certificate belongs, the stock certificate number, the acquisition date of the stock certificate, the number of shares issued, the number of remaining shares, and the process type.

The VC fund then has the option to create an action to distribute a specified number of shares from one or more stock certificates. However, the VC fund cannot, in a single action, includes stock certificates of different process types (e.g., Rule 144, Rule 701, Rule 144K) nor stock certificates issued by different Issuers.

If the VC fund does not create an action (step 808-No), the VC fund signs off of server 20.

If however, the VC fund chooses to create an action (step 808-Yes), an action-ID is created by controller 260 (step 809) and action verification data is displayed (step 810). This data includes the Issuer of the one or more stock certificate selected, the stock certificate number of each stock certificate selected, and the total number of shares remaining for each stock certificate selected. The action-ID created by controller 260 is preferably displayed as well. Furthermore, the VC fund is presented with a standard text box for the entry of the number of shares to be acted upon for each stock certificate selected. The data also preferably includes additional information for the purpose of avoiding errors or delays in the process of completing the selected action. For example, the action verification data can include a reminder about the regulatory and legal responsibilities imposed on the VC fund during this process.

Upon entering the desired number of shares and reviewing the displayed information, the VC fund has the option to continue the process (i.e., verify the action) or suspend and save the action (step 812).

If the VC fund suspends and saves the action (step 812-No), the VC fund is prompted to enter status comments regarding the action (step 814). Controller 260 then saves the action details (e.g., the number shares of each selected stock certificate as defined by the VC fund) and status comments in database 240 (step 816). Action status data, as described below (beginning with reference to step 862 of FIG. 8D), is then displayed for the VC fund.

If the VC fund continues processing the action (step 812-Yes), the VC fund is prompted to create a distribution table (step 818, FIG. 8B). A distribution table specifies the share each partner of the VC fund is to receive as a result of the distribution. To complete this task, the VC fund preferably has a number of options. For example, the VC fund can request the retrieval of a distribution table template from database 240. When the VC fund proceeds in this fashion, controller 260 determines the share each VC fund partner is to receive by reference to the share of each selected stock certificate owned by each limited partner. For example, if only one stock certificate is included in an action and a first partner of the VC fund owns 40% of the stock certificate, the first partner of the VC fund will receive 40% of the distribution. Another option is to import a distribution table from a different source (e.g., the memory of user computer 30). In this case, the VC fund must determine the share of the distribution received by each limited partner. Either way, the VC fund can view and edit the distribution table using a compatible word processor or spreadsheet program (e.g., Microsoft Excel or Corel Quattro Pro). Additionally, the VC fund can selectively ignore the distribution table requirement. If so, the VC fund is preferably prompted to enter an explanation in a dialog box. This information is accessible by subsequent users concerned about the absence of the distribution table.

At any time during the process of creating a distribution table, the VC fund can suspend and save the action (step 820-No). The VC fund is then prompted to enter status comments regarding the action (step 822). Controller 260 then saves the action details and status comments in database 240 (step 824). Action status data, as described below (beginning with reference to step 862 of FIG. 8D), is then displayed for the VC fund.

The VC fund can also continue the process after creating a distribution table (step 820-Yes). If so, controller 260 confirms that the distribution table has been created or selectively ignored by the VC fund (step 826). If not, the VC fund is returned to the step of creating a distribution table (step 826-No).

If on the other hand, controller 260 confirms that the distribution table has been created or selectively ignored by the VC fund (step 826-Yes), the VC fund is given the opportunity to create documents necessary to the completion of the action (step 828). Examples of such documents include a separate distribution letter to each limited partner, Legal Counsel, a Transfer Agent, and if necessary, a Broker. A Broker is typically notified if a sale is likely to follow the distribution action. These letters are typically the same for each entity named, and serve as notification of the distribution action. In this stage, the term “required” is used loosely. The distribution letters are not required by any particular entity or regulatory authority; however, embodiments of the invention preferably allow the generation of these documents to facilitate the process. Another document usually created during this stage is an Agreement of transferee. This document is an agreement imposes on the party receiving the shares as a result of the distribution restrictions imposed on the current holder of the stock certificate. Furthermore, the VC fund can create documents in anticipation of a sale following the distribution action as noted above. This documentation includes, for example, a Rule 144 Form, seller's representation letter, Broker's representation letter, or other documentation. While this documentation is not required at this stage, a VC fund often includes the documentation as a service to the partners. For each required document, the VC fund can retrieve document templates from database 240 using Internet browser 340 and web pages from Website 230. These documents are preferably created when an account is created for the VC fund. Essentially, these documents include any information deemed by the VC fund, in accordance with SEC regulations, to be important to the distribution action. The VC fund also has the option of importing a document from a different source (e.g., the memory of user computer 30). In either case, the VC fund can view and edit the documents using a compatible word processor. Additionally, the VC fund can selectively ignore the documentation requirements. If so, the VC fund is preferably prompted to enter an explanation in a dialog box. This information is then accessible by subsequent users concerned about the absence of required documentation.

At any time during the process of creating documentation, the VC fund can suspend and save the action (step 830-No). The VC fund is then prompted to enter status comments regarding the action (step 832). Controller 260 then saves the action details and status comments in database 240 (step 834). Action status data, as described below (beginning with reference to step 862 of FIG. 8D), is then displayed for the VC fund.

The VC fund can also continue the process (step 830-Yes). If so, controller 260 confirms that each required document has been created or selectively ignored by the VC fund (step 836). If not, the VC fund is returned to the step of creating documents (step 836-No). If on the other hand, controller 260 confirms that each required document has been created or selectively ignored by the VC fund (step 836-Yes), the VC fund is given an opportunity to review the action (step 838). During this review, the VC fund preferably has the option of entering Broker identification information (e.g., Brokerage firm, Broker name, assistant name, email address, phone number, fax number, etc.). Finally, the VC fund can elect to review an automated notifications list upon completing the review and continuing action processing.

At any time during the process of creating documentation, the VC fund can suspend and save the action (step 840-No, FIG. 8C). If so, the VC fund is prompted to enter status comments regarding the action (step 842). Controller 260 then saves the action details and status comments in database 240 (step 844). Action status data, as described below (beginning with reference to step 862 of FIG. 8D), is then displayed for the VC fund.

If the VC fund continues processing the action (step 840-Yes) and has elected to review the automated notifications list (step 840-Yes), the VC fund is presented with a list of persons or entities that are notified when the VC fund releases the action to the next stage (step 842). The list includes identification information (e.g., firm, name, assistant name, e-mail address, phone number, fax number, etc.). The list is preferably initialized with data maintained in database 240. This data is provided by a VC fund when an account is created for the VC fund on server 20.

At any time during the process of creating documentation, the VC fund can suspend and save the action (step 852-No). If so, the VC fund is prompted to enter status comments regarding the action (step 858). Controller 260 then saves the action details and status comments in database 240 (step 860). Action status data, as described below (beginning with reference to step 862 of FIG. 8D), is then displayed for the VC fund.

If the VC fund continues processing the action after reviewing the automated notifications (step 852-Yes) or if the VC fund did not elect to review the automated notifications after reviewing the action (step 846-Yes, step 852-No), the status of the action is updated and the action is released to the next stage (step 854). Notifications of the release of the action to the next stage are also sent to the defined recipients (step 856).

Controller 260 then preferably creates for each partner of the VC fund 1) an action to delegend the stock certificates to be received as a result of the distribution action, and 2) a new entry in the holdings data reflecting the stock certificate to be received as a result of the distribution action (step 857). Because stock certificates have not yet been issued by the Transfer Agent to any of the partners, the stock certificate described in the holdings data as a result of this step does not include a stock certificate number. However, information describing the stock certificate (e.g., Issuer of the stock, legend type, legend text, affiliate status of the VC fund, date of acquisition, date of automatic legend restriction change or termination, manner of acquisition, broker information if relevant, and links to the records of the Issuer, and Broker as needed) is obtained from the sub-record in database 240 describing the stock certificate selected for distribution. This information is also reflected in each action to delegend the stock certificate created in step 857. Accordingly, the various entities involved in the delegending process as described above have sufficient information to complete the delegending process even though the distribution process is not yet complete. Each action created in step 857 is displayed to the Transfer Agent selected to complete the distribution action as described in step 1002 below. The Transfer Agent can then determine what type of certificate to create as a result of the distribution action. For example, if a partner designated to receive a portion of the distributed stock certificate chooses to release an action created in step 857 to the next stage, the Transfer Agent will not create a restricted stock certificate for delivery to the limited partner. Instead, the Transfer Agent will wait until the delegending process is complete to create an unrestricted stock certificate for delivery to the limited partner. This allows the Transfer Agent to avoid creating a restricted stock certificate that will be replaced at the close of the delegending process.

Generally, after the action is released to the next stage, the VC fund signs off of server 20 and exits the system. However, the VC fund can also return to view the holdings data (as described above with reference to step 804) or view data related to pending actions (as described below with reference to step 862).

Controller 260 retrieves from database 240 and transfers to user computer 30 data relating to pending actions (step 862). The data is then displayed to the VC fund (step 864). This data encompasses actions that were and were not released by the VC fund to the next stage. For each action, an entry including the action-ID, action status, stock certificate fund, stock certificate numbers, number of shares included in the action, Brokerage firm, stock certificate Issuer, Legal Counsel, and Transfer Agent is displayed. If the VC fund suspended and saved the action, the status of the action indicates that the VC fund has not released the action yet. If on the other hand, the VC fund has already released the action to the next stage of processing, the status displayed is indicative of the current stage of processing (e.g., Legal Counsel or Transfer Agent).

The VC fund can view details of a listed action or sign-off of server 20 (step 866). If the VC fund chooses to view details of a listed action (step 866-Yes), controller 260 retrieves and transfers additional action data to user computer 30 (step 868), which is displayed for the VC fund (step 870). If the VC fund is an action that has not been released to the next stage by the VC fund, the VC fund can continue processing the action (step 872-Yes) or return to the displayed list of pending actions (step 872-No). If the VC fund continues processing an action (step 868-Yes), controller 260 returns the VC fund to the step of the process at which the VC fund elected to suspend and save the action (step 874).

The next stage of the process, Stage II of Process II, is generally completed by Legal Counsel. Essentially, an attorney has to issue a legal opinion representing that the distribution is not in violation of applicable regulations. Similar to the delegending process, Legal Counsel may or may not consist of employees of the Issuer of the selected stock certificates. The processing steps executed during the stage are illustrated in FIGS. 9A-9C.

This stage begins with the attorney signing on to server 20 (step 900, FIG. 9A). After Legal Counsel is signed on, controller 260 retrieves from database 240 and transfers to user computer 30 data relating to pending actions that require processing by Legal Counsel (step 902). The data is then displayed to Legal Counsel (step 904). This data encompasses actions that were partially processed by Legal Counsel and actions that have just entered or re-entered the stage completed by Legal Counsel. For each action, an entry including the action-ID, action status, Holder, stock certificate fund, stock certificate numbers, number of shares included in the action, Brokerage firm, stock certificate Issuer, Legal Counsel, and Transfer Agent is displayed.

Upon viewing the action data, Legal Counsel can process an action (step 906-Yes) or sign-off of server 20 (step 906-No). If Legal Counsel chooses to process an action (step 906-Yes), controller 260 retrieves and transfers additional action data and action documents to user computer 30 (step 908). The additional action data is displayed for Legal Counsel (step 910).

Legal Counsel then has the option to review the work completed for the action (step 912). This step includes reviewing the documentation completed in earlier stages. Access to the documents is provided on the display by, for example, a hyperlink. When Legal Counsel has selected a document, a compatible word processor is used to display the contents of the document. However, since none of the documentation created in Stage I of Process II is absolutely required, the review process focuses on other factors. For example, the Legal Counsel confirms that the representative of the VC fund has the authority to distribute the stock certificate. Occasionally, a VC fund mistakenly selects the wrong stock certificate for distribution. The Legal Counsel also checks for 1) a pending corporate transaction, 2) material new announcement, and 3) a secondary offering by the Issuer of the selected stock certificate. Generally, if the Holder is affiliated with the Issuer, these types of activities preclude a distribution action.

After reviewing the action, Legal Counsel has the option to approve the action (step 914). If Legal Counsel does not approve the action (step 914-No), controller 260 prompts Legal Counsel to submit a reason for not approving the action (step 916). Controller 260 then updates the status of the action (918), which includes saving the reason or reasons for not approving the action in database 240, and sends notifications to the person or entities notified in step 856 of FIG. 8C (step 920). Controller 260 then retrieves and transfers to user computer 30 data for all actions pending Legal Counsel interaction (step 902), which is displayed for Legal Counsel (step 904) as described above.

If Legal Counsel approves the action (step 914-Yes), Legal Counsel is given the opportunity to create documents necessary to the completion of the action (step 922, FIG. 9B). Essentially, this means that Legal Counsel generates an opinion letter stating approval for the distribution action. The precise documents required are dictated by SEC regulations. Accordingly, embodiments of the invention are designed with enough flexibility to modify the documents required at any stage of the process. For each of these documents, and any other optional documentation, Legal Counsel can retrieve document templates from database 240 using Internet browser 340 and web pages from Website 230. These documents are preferably created when an account is created for Legal Counsel. Essentially, these documents include any information deemed by Legal Counsel, in accordance with SEC regulations, to be important to the distribution process. Legal Counsel also has the option of importing a document from a different source (e.g., the memory of user computer 30). In either case, Legal Counsel can view and edit the documents using a compatible word processor. Additionally, Legal Counsel can choose to ignore the document requirements. If so, Legal Counsel is preferably prompted to enter an explanation in a dialog box. This information is then accessible by subsequent users concerned about the absence of required documents.

Legal Counsel is also preferably given, at this step of the process, the option to specifying the next person within the Legal Counsel entity to review the action. Often, more than one person must review an action before the action is released to the next stage. The present invention is designed to allow Legal Counsel to specify in advance the names and order of reviewers within the organization. Thus, when the VC fund releases an action to Legal Counsel stage, a designated person is given the task of reviewing the action first. Further, at this step of the process, controller 260 can automatically display the name and email address of the next person within Legal Counsel to review the action. If the final reviewer has been reached, no such information is included.

At any time after the process of creating documents begins, Legal Counsel can suspend and save the action (step 924-No). Legal Counsel is then prompted to enter status comments (step 926), which are saved with the action details in database 240 (step 928). Controller 260 then retrieves and transfers to user computer 30 data for all pending actions (step 902), which is displayed for Legal Counsel (step 904) as described above.

Legal Counsel can also continue processing the action (step 924-Yes). If so, controller 260 confirms that each required document has been created or selectively ignored by Legal Counsel (step 930). If not, Legal Counsel is returned to the step of creating documents (step 930-No). If on the other hand, controller 260 confirms that each required document has been created or selectively ignored by Legal Counsel (step 930-Yes), processing of the action continues.

The next step executed depends upon whether an additional person within the Legal Counsel entity is specified in step 922 (step 932). If so (step 932-Yes), controller 260 updates the action status (step 933) and sends a notification to the person designated in step 922 (step 934). In a preferred embodiment of the invention, the parties notified according to the automated notification list discussed with reference to, for example, step 856, are not necessarily notified in this instance so that Legal Counsel can maintain a certain amount of internal autonomy. Thus, persons outside of the Legal Counsel organization know only that Legal Counsel is still processing the action. Controller 260 then retrieves and transfers to user computer 30 data for all pending actions (step 902), which is displayed for Legal Counsel (step 904) as described above.

If an additional person is not designated to review the action in step 922, Legal Counsel is given an opportunity to conduct a final review the action (step 935). Essentially, action data is displayed for Legal Counsel again before the action is released by Legal Counsel to the next stage. Legal Counsel can also elect to review an automated notifications list upon completing the review and continuing to the next step of action processing.

At any time after the final review begins, Legal Counsel can suspend and save the action (step 936-No). If so, Legal Counsel is then prompted to enter status comments (step 938), which are saved with the action details in database 240 (step 940). Controller 260 then retrieves and transfers to user computer 30 data for all pending actions (step 902), which is displayed for Legal Counsel (step 904) as described above.

If Legal Counsel chooses to continue processing the action (step 936-Yes) and has elected to review the automated notifications list (step 942-Yes, FIG. 9C), Legal Counsel is presented with a list of persons or entities that are notified when Legal Counsel finally releases the action to the next stage of the process (step 944). The list includes identification information (e.g., firm, name, assistant name, e-mail address, phone number, fax number, etc.). The list is preferably initialized with data maintained in database 240 and updated by the VC fund in step 848.

At any time after the process of reviewing the automated notifications list begins, Legal Counsel can suspend and save the action (step 948-No). If Legal Counsel does so, Legal Counsel is prompted to enter status comments (step 954), which are saved with action details in database 240 (step 956). Controller 260 then retrieves and transfers to user computer 30 data for all pending actions (step 902), which is displayed for Legal Counsel (step 904) as described above.

If Legal Counsel chooses to continue processing the action after reviewing the automated notifications (step 948-Yes) or if Legal Counsel did not elect to review the automated notifications after reviewing the action (step 936-Yes, step 942-No), the status of the action is updated (i.e., the action is released to the next stage) (step 950) and the notifications are sent to the defined recipients (step 952). The notifications alert the other parties about the release of the action to the next stage by Legal Counsel.

The next and final stage of the process, Stage III of Process II, is generally completed by a Transfer Agent. The Transfer Agent exchanges the selected stock certificates held by the VC fund for shares for stock certificates for each partner of the VC fund. In so doing, the Transfer Agent relies, in particular, on the opinion letter drafted by Legal Counsel. Without this letter, a Transfer Agent cannot legally exchange the shares. The processing steps executed during Stage III are illustrated in FIGS. 10A-10C.

This stage begins with the Transfer Agent signing on to server 20 (step 1000, FIG. 10A). After the Transfer Agent is signed on, controller 260 retrieves from database 240 and transfers to user computer 30 data relating to pending actions that require processing by the Transfer Agent (step 1002). The data is then displayed to the Transfer Agent (step 1004). This data encompasses actions that were partially processed by the Transfer Agent and actions that have just entered or re-entered Stage III. For each action, an entry including the action-ID, action status, Holder, stock certificate fund, stock certificate numbers, number of shares included in the action, Brokerage firm, stock certificate Issuer, Legal Counsel, and Transfer Agent is displayed.

Upon viewing the action data, the Transfer Agent can process an action (step 1006-Yes) or sign-off from the server 20 (step 1006-No). If the Transfer Agent chooses to process an action (step 1006-Yes), controller 260 retrieves and transfers additional action data and action documents to user computer 30 (step 1008). The additional action data is displayed for the Transfer Agent (step 1010).

The Transfer Agent then has the option of reviewing the work completed for the action (step 1012). In part, this step includes reviewing the documentation completed in earlier stages. Typically, a Transfer Agent is only concerned about the legal opinion created by the Legal Counsel. Access to the documents is provided on the display by, for example, a hyperlink. Once the Transfer Agent has selected a document, a compatible word processor is used to display the contents of the document. Additionally, the Transfer Agent requires the original selected restricted stock certificates (with each signed by the VC fund) or a Stock Power and a Medallion or Bank Guaranty to guarantee the signatures.

After reviewing the action, the Transfer Agent has the option to approve the action (step 1014). If the Transfer Agent does not approve the action (step 1014-No), controller 260 prompts the Transfer Agent to submit a reason for not approving the action (step 1016). Controller 260 then updates the status of the action (1018), which includes saving the reasons for not approving the action in database 240, and sends notifications to the person or entities notified in step 856 of FIG. 8C, step 952 of FIG. 9C by a VC fund and Legal Counsel respectively (step 1020). When the action is not approved, responsibility for the action returns to an earlier stage. Controller 260 then retrieves and transfers to user computer 30 data for all pending actions (step 1002), which is displayed for the Transfer Agent (step 1004) as described above.

If the Transfer Agent approves the action (step 1014-Yes), the Transfer Agent is given the opportunity to create documents necessary to the completion of the action (step 1022, FIG. 10B). For each document created and reviewed, the Transfer Agent can retrieve a document template from database 240 using Internet browser 340 and web pages from Website 230. These documents are preferably created when an account is created for the Transfer Agent. Essentially, these documents include any information deemed by the Transfer Agent, in accordance with SEC regulations, to be important to the process of delegending stock certificates. The Transfer Agent also has the option of importing a document from a different source (e.g., the memory of user computer 30). In either case, the Transfer Agent can view and edit the documents using a compatible word processor. Additionally, the Transfer Agent can ignore the document requirements. If the Transfer Agent chooses to do so, he or she is preferably prompted to enter an explanation in a dialog box. This information is then be accessible by subsequent users concerned about the absence of one or more documents.

At any time after the process of creating documents begins, the Transfer Agent can suspend and save the action (step 1024-No). The Transfer Agent is then prompted to enter status comments (step 1026), which are saved with the action details in database 240 (step 1028). Controller 260 then retrieves and transfers to user computer 30 data for all pending actions (step 1002), which is displayed for the Transfer Agent (step 1004) as described above.

The Transfer Agent can also continue the process (step 1024-Yes). If so, controller 260 confirms that each required document has been created or selectively ignored by the Transfer Agent (step 1030). If not, the Transfer Agent is returned to the step of creating documents (step 1030-No). If on the other hand, system 10 confirms that each required document has been created or selectively ignored by the Transfer Agent (step 1030-Yes), processing of the action continues.

The Transfer Agent is given the opportunity to conduct a final review the action (step 1032). Essentially, action data is displayed for the Transfer Agent again before the action is closed by the Transfer Agent. The Transfer Agent can also elect to review an automated notifications list upon completing the review and continue processing the action.

At any time after the final review begins, the Transfer Agent can suspend and save the action (step 1034-No). The Transfer Agent is then prompted to enter status comments (step 1036), which are saved with the action details in database 240 (step 1038). Controller 260 then retrieves and transfers to user computer 30 data for all pending actions (step 1002), which is displayed for the Transfer Agent (step 1004) as described above.

If the Transfer Agent chooses instead to close the action (step 1034-Yes) and has elected to review the automated notifications list (step 1040-Yes, FIG. 10C), the Transfer Agent is presented with a list of persons or entities that are notified when the Transfer Agent finally releases the action to the next stage of the delegending process (step 1042). The list includes identification information (e.g., firm, name, assistant name, e-mail address, phone number, fax number, etc.).

At any time after the process of reviewing the automated notifications list begins, the Transfer Agent can suspend and save the action (step 1046-No). If so, the Transfer Agent is prompted to enter status comments (step 1048), which are saved with action details in database 240 (step 1050). Controller 260 then retrieves and transfers to user computer 30 data for all pending actions (step 1002), which is displayed for the Transfer Agent (step 1004) as described above.

If the Transfer Agent chooses to close the action after reviewing the automated notifications (step 1046-Yes) or if the Transfer Agent did not elect to review the automated notifications after reviewing the action (step 1034-Yes, step 1040-No), the status of the action is updated (i.e., the action is closed) (step 1052) and the notifications are sent to the defined recipients (step 1054).

As noted above, the VC fund may elect to distribute only some of the shares included in a selected restricted stock certificate. When this occurs, the selected restricted stock certificate entry in the holdings data is modified to reflect the reduced number of shares remaining. This prevents a VC fund from attempting to distribute shares no longer available. When the distribution process is closed by a Transfer Agent, controller 260 or the Transfer Agent closing the distribution process creates a new entry in the holdings data to represent a newly created restricted stock certificate that includes the remaining shares of the selected restricted stock certificate and deletes the selected restricted stock certificate entry (step 1056). This process is required because the Transfer Agent must create a new restricted stock certificate and destroy the previous stock certificate. All of the data from the previous restricted stock certificate entry is incorporated in the new entry. One exception to this is that the number of shares issued data and the number of shares remaining data is set to reflect the reduced number of shares available. Additional data that is changed includes the date of creation and the stock certificate number.

The Transfer Agent is also given the option (step 1058-Yes) to update the stock certificate entries created for each partner as a result of the distribution action (step 1060). If the Transfer Agent declines, Controller 260 then retrieves and transfers to user computer 30 data for all pending actions (step 1002), which is displayed for the Transfer Agent (step 1004) as described above.

In another aspect of the invention, a stock certificate holdings record is created from data related to a stock certificate. The data is provided by the issuer of the stock certificate if the issuer is, for example, the surviving entity of a merger or acquisition. A holder of a stock certificate of a corporations that formed the issuer as a result of the merger or acquisition will eventually receive a stock certificate issued by the issuer in exchange for a stock certificate issued by the corporation.

As noted above, this process traditionally results in the holder not being able to view or process data related to the stock certificate until the stock certificate is received by the holder. This is no longer true because of the present invention.

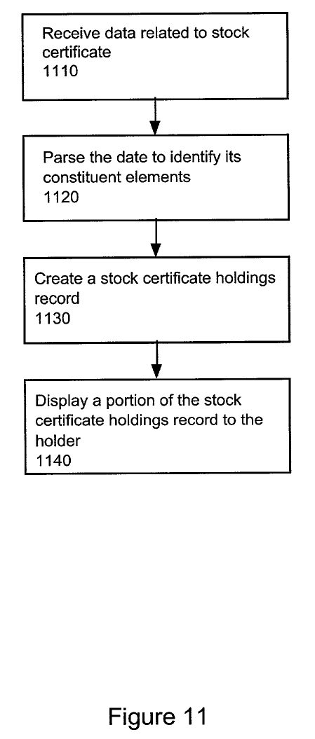

Processing steps of a preferred embodiment of the present invention are illustrated in FIG. 11. In a first step, data related to a stock certificate is received (step 1110). The data may originate from an issuer, a transfer agent (i.e., an agent of the issuer), or other agent of the issuer. Delivery of this data can take many forms. In one embodiment of the invention, the issuer submits a spreadsheet file. The spreadsheet file is typically submitted as an attachment to an email or as a file on a floppy disk sent via traditional mail. The spreadsheet includes various columns of data as described below. When the data is received in this fashion, it is subsequently uploaded to database 240.

In another embodiment of the invention, the issuer signs on to server to upload the data directly to database 240 from user computer 30.

The data related to stock distributed to a holder preferably includes: the name of the holder, holder type, the taxpayer ID of the holder, the address of the holder, the stock certificate number, the stock certificate date, the type of the stock, the total number of shares on the stock certificate, the number of shares that are vested issuer shares, the number of shares that are un-vested issuer shares, the number of shares that are raw issuer shares as converted, the actual number of issuer share actually issuable, the number of shares that are fractional issuer shares, the total number of escrow shares, the number of vested escrow shares, the number of un-vested escrow shares, the number of issuer certificate shares issued at closing, the number of issuer book-entry shares issued at closing, the amount of cash paid for fractional shares, whether there is an outstanding loan, and the legends on the certificate. Accordingly, the spreadsheet file described above includes separate columns of data for some or all of these items of data.

After the data is received, it is parsed to identify its constituent elements (step 1120). The data may arrive in a form that is not compatible with the structure of stock certificate holdings records in database 240. When this occurs, parsing the data includes restructuring the data as needed. For example, the data received from the issuer may have a single field or column for information that is separated into two or more fields or columns of data in a stock certificate holdings record. Additionally, the data must be scanned to ensure that all required constituent elements are present. For example, a taxpayer ID and holder type are required. The reason is that the same taxpayer ID can be used for different types of holder accounts. This might occur when a person has a first holder record identifying the holder type as an individual account and including the person's taxpayer ID and a second holder record identifying the holder type as a joint account (e.g., an account held with a spouse) and including the person's taxpayer ID. Because the taxpayer ID and holder type for both holder records do not match, the taxpayer ID may be used for two holder records. Thus, step 1130, as described below, can not be executed without these constituent elements. If a required element is missing, the issuers must supply the missing information or resubmit the data in its entirety.

Step 1120 is often completed with the assistance of a computer program. The computer program is designed to detect inconsistencies and other problems with the data before executing step 1130. For example, the computer program searches database 240 for 1) records having a taxpayer ID that is included in the data received in step 1110; 2) records of stock certificates having the same stock certificate number that is included in the data received in step 1110; and 3) records of stock certificates issued by the issuer identified in the data received in step 1110 to verify that the stock certificate number of the stock certificate identified in the data received in step 1110 correctly identifies the issuer.

Once a problem is identified by the computer program, corrective measures may be taken. For example, if a duplicate taxpayer ID is identified, it must be determined that the holder name matches as well. Additionally, if a duplicate stock certificate number is found, the data received in step 1110 is corrected because stock certificate numbers are unique.

After the data has been received and parsed, a stock certificate holdings record is created (step 1130). This step includes creating a holder record if a holder identified in the data received from the issuer does not already have a holder record in database 240 of the same holder type identified in the data received in step 1110. Whether the holder already has a holder record is determined by reference to the holder's name, taxpayer ID, and holder type. Thus database 240 is scanned for records with taxpayer ID, holder type, and name combinations that match the information submitted by the issuer.

If no match is found, a holder record is created. The holder record preferably includes the holder's name, taxpayer ID, contact information, and a list of persons authorized to act on the holder's behalf. Information not provided by the issuer, such as the list of persons authorized to act on the holder's behalf, may be submitted afterwards.

Additionally, an account is created for the holder so that the holder may access the holder record and holder sub-records (i.e., stock certificate holdings records). More specifically, this account permits the holder to sign on to Server 20 and access database 240.

After a holder record is created, a stock certificate holdings record is created for the holder. This record preferably includes: the issuer of the stock, a stock certificate number, legend type, legend text, affiliate status of the holder, date of acquisition, date of automatic legend restriction change or termination, manner of acquisition, and broker information if relevant.

Note that the information received in step 1110 may not always include all of the information included in the holder record. Often times, data included in a stock certificate holdings record is inherited from a previous stock certificate holdings record. As noted above, a stock certificate of a corporation subject to a merger or acquisition is exchanged for a stock certificate issued by the resulting corporation (i.e., issuer). Thus, a stock certificate holdings record already exists. Information such as date of acquisition and acquisition price included in the existing stock certificate holdings record is still valid. Additionally, a holder may have purchased stock in a company on numerous occasions. Thus, the holder would have numerous stock certificate holdings records for the company. If however, the company is subject to a merger or acquisition, the resulting company may issue only one stock certificate in exchange for the numerous stock certificates held. The date of acquisition and acquisition price for each of the separate purchases is maintained in the stock certificate holdings record.

The stock certificate holdings record is accessed by reference to the holder's record, which includes links the holder's stock certificate holdings records. Thus, each holder has a holder's record and a record for each stock certificate held by the holder.

In step 1140, the stock certificate holdings record is displayed to the holder. As indicated above, the holder must sign on to Server 20 before viewing the holder's records. And as explained more fully above, a holder preferably accesses server 20 and database 240 via the Internet and an Internet browser.

Upon viewing the stock certificate holdings record, the holder may initiate the process of delegending a restricted stock certificate holding as described above with reference to FIGS. 4A-4D.

Note that the data received in step 1110 often contains information for numerous holders. Thus, for each holder identified in the data received in step 1110, steps 1120, 1130, and 1140 are repeated.

While the present invention has been described with reference to the preferred embodiments, those skilled in the art will recognize that numerous variations and modifications may be made without departing from the scope of the present invention. Accordingly, it should be clearly understood that the embodiments of the invention described above are not intended as limitations on the scope of the invention, which is defined only by the claims that are now or may later be presented.

What is claimed is:

1. A method for creating a stock certificate holdings record, comprising:
receiving data related to a stock certificate;
parsing said data to identify its constituent elements;
creating a stock certificate holdings record for a holder identified in said data, said stock certificate holdings record based upon said constituent elements; and
displaying a portion of said stock certificate holdings record to the holder over a computer network.

2. The method of claim 1, wherein said receiving step comprises receiving a data file from the issuer.

3. The method of claim 1, wherein said receiving step comprises said issuer uploading said data directly to a computer system configured to maintain stock certificate holdings records.

4. The method of claim 1, wherein said parsing step includes a computer program comparing said data to an existing stock certificate holdings record to identify an error in said data.

5. The method of claim 4, wherein said error includes the existing stock certificate holdings record having a stock certificate number included in said data.

6. The method of claim 4, wherein said error includes the existing stock certificate holdings record having a first identifier of an issuer of a stock certificate and said data having a second identifier of the issuer.

7. The method of claim 1, wherein said creating step includes creating an account based on said data for the holder, said account providing access for said holder to said stock certificate holdings record.

8. The method of claim 1, wherein said creating step includes creating a holder record, said holder record including a link to said stock certificate holdings record.

9. The method of claim 1, wherein said data describes a plurality of holders, such that said creating step and said displaying step are repeated for each of said plurality of holders.

10. The method of claim 1, wherein said computer network is the Internet.

11. The method of claim 1, wherein said data is also related to a merger of two or more corporations.

12. The method of claim 1, wherein said data is also related to an acquisition of a first corporation by a second corporation.

13. The method of claim 1, wherein said data is also related to an initial public offering by a corporation.

14. A computer program product for use in conjunction with a computer system, the computer program product comprising a computer readable storage medium and a computer program mechanism embedded therein, the computer program mechanism comprising:
instructions for receiving data related to a stock certificate;
instructions for parsing said data to identify its constituent elements;
instructions for creating a stock certificate holdings record for a holder identified in said data, said stock certificate holdings record based upon said constituent elements; and
instructions for displaying a portion of said stock certificate holdings record to the holder over a computer network.

15. The computer program product of claim 14, wherein said data is a data file received from an issuer of the stock certificate.

16. The computer program product of claim 14, wherein said computer program mechanism further comprises instructions for receiving said data when uploaded directly to the computer system, said computer system configured to maintain stock certificate holdings records.

17. The computer program product of claim 14, wherein said computer program mechanism further comprises instructions for comparing said data to an existing stock certificate holdings record to identify an error in said data.

18. The computer program product of claim 17, wherein said error includes the existing stock certificate holdings record having a stock certificate number included in said data.

19. The computer program product of claim 17, wherein said error includes the existing stock certificate holdings record having a first identifier of an issuer of a stock certificate and said data having a second identifier of the issuer.

20. The computer program product of claim 14, wherein said computer program mechanism further comprises instructions for creating an account based on said data for the holder, said account providing access to said stock certificate holdings record.

21. The computer program product of claim 14, wherein said computer program mechanism further comprises instructions for creating a holder record, said holder record including a link to said stock certificate holdings record.

22. The computer program product of claim 14, wherein said data describes a plurality of holders, such that said instructions for creating a stock certificate holdings record for a holder identified in said data and said instructions for displaying a portion of said stock certificate holdings record are executed for each of said plurality of holders.

23. The computer program product of claim 14, wherein said computer network is the Internet.

24. The computer program product of claim 14, wherein said data is also related to a merger of two or more corporations.

25. The computer program product of claim 14, wherein said data is also related to an acquisition of a first corporation by a second corporation.

26. The computer program product of claim 14, wherein said data is also related to an initial public offering by a corporation.
